(19) United States
(12) Patent Application Publication
(10) Pub. No.: US 2010/0285283 A1
(43) Pub. Date: Nov. 11, 2010

(54) FASHION ACCESSORIES MADE FROM TRAFFIC CONE RUBBER

(76) Inventor: Nicholas Scot Kingsbury, Huntington Station, NY (US)

Correspondence Address: Limin Wen, One Bungtown Road, Nichols Building, 1st Floor, Cold Spring Harbor, NY, 11724, US

(21) Appl. No.: 12/727,343

(22) Filed: Mar. 19, 2010

Related U.S. Application Data
(60) Provisional application No. 61/163,570, filed on Mar. 26, 2009.

(51) Int. Cl. A44C 9/00; A45C 1/06; A41C 3/00; B65D 90/00; A45C 11/18; A45F 5/00; A45D 8/00; A44C 5/00; A42B 1/00; A41D 3/08; A45C 3/06; A44C 7/00; A44C 25/00; A41F 9/00; A43B 5/00; A44B 19/26; A47G 29/00; A44B 1/00; A44B 1/04; A44B 15/00; B44F 7/00

(52) U.S. Cl. 428/195.1; 150/132; 450/93; 206/524.6; 150/147; 224/101; 132/273; 63/15; 63/3; 2/200.1; 2/84; 150/100; 63/12; 63/33; 2/311; 36/114; 24/415; 248/346.11; 24/90.1; 24/102 R; 70/456 R; 40/800; 428/215

(57) ABSTRACT

The present invention relates generally to fashion accessories designed and made from traffic cone rubber, more particularly related to Bracelets, Key Chains, Necklace Pendants, Earrings, Rings, Wallet, Belts, Zipper Pulls, Belly Button Piercing, Bookmarks, Bra, Door Hanger, Cell phone/Beeper/Pager Holder, Ipod Case, Cell Phone Charm, Wall Mask, Winter Hat/Beanie Hat, Baseball Cap, Tie, Hoodie, Satchel Bag, Sneaker, Decal Snaps, Money Clip, Magnet, Backpack, Watch Band, Relief Carving, Eyeglass Case, Headband, Coaster, Car Decoration, Ornament, Pet Products, Hair Clip, Change Purse, Purse, Pins/Buttons, Anklet, Lanyard, Nose Piercing, Charms, Button, and Cufflinks.

### REFERENCE TO RELATED APPLICATION

This application claims the benefit of the filing date of U.S. Provisional Application Ser. No. 61/163,570, entitled “Fashion accessories made from traffic cone rubber” and filed on Mar. 26, 2009. The teachings of the entire referenced application are incorporated herein by references.

### FIELD OF THE INVENTION

This invention relates generally to fashion accessories designed and made from traffic cone rubber, including but not limited to bracelets, key chains, necklace pendants, earrings, rings, wallet, belts, etc.

### BACKGROUND OF THE INVENTION

Teenagers and young adults like to wear novel or unique fashion accessories such as jewelry, key chain, wallet, belt, etc. They are looking for fancy design and inexpensive fashion accessories for their wearing.

In practice, most of fashion accessories such as jewelries are made from gold, silver, or diamond, which most teenagers and young adults cannot afford. There are many cheap fashion accessories are made from plastic, glass, or wood, which look very normal and not attractive to these teenagers and young adults.

The present invention targets the above need of these teenagers and young adults, providing a series of fashion accessories made entirely out of traffic cone rubber with unique features and designs. By now, there is no any fashion accessory or jewelry made from traffic cone rubber has been found in the art.

The above traffic cone rubber is the exact same rubber polymer used in regular traffic cones which have overall thickness of 3.75 mm+/−0.05 mm with two layers (orange over white). The orange layer has thickness of 1.32 mm+/−0.025 mm; the white layer has thickness of 2.43 mm+/−0.025 mm. Such traffic cone rubber used in this invention glows under ultra-violet light, has the same durability, flexibility, and carvability of traffic cone material and has the same durometer and elasticity as traffic cone material.

### SUMMARY OF THE INVENTION

The present invention relates generally to fashion accessories designed and made from traffic cone rubber, more particularly related to Bracelets, Key Chains, Necklace Pendants, Earrings, Rings, Wallet, Belts, Zipper Pulls, Belly Button Piercing, Bookmarks, Bra, Door Hanger, Cell phone/Beeper/Pager Holder, Ipod Case, Cell Phone Charm, Wall Mask, Winter Hat/Beanie Hat, Baseball Cap, Tie, Hoodie, Satchel Bag, Sneaker, Decal Snaps, Money Clip, Magnet, Backpack, Watch Band, Relief Carving, Eyeglass Case, Headband, Coaster, Car Decoration, Ornament, Pet Products, Hair Clip, Change Purse, Purse, Pins/Buttons, Anklet, Lanyard, Nose Piercing, Charms, Button, and Cufflinks. These fashion accessories consist of a product line called “Hazard Line”.

Each of these fashion accessories has different designs or styles as described below:

1) Bracelets include: Leopard style, Hazard style, Phrase Band style, Flower Petal style, Hazard Braid style, Stripper style, etc.
2) Key Chains include: Rebel Head Smirk, Rebel Head Jax, Rebel Head Blaa, Rebel Head Lips, Skull, Flower, Rebel Head Texty, Rebel Head Punchy, Rebel Head Winks, Mushroom, Sea Shell, etc.
3) Necklace Pendants include: Sunrise, Bubble Heart, Crossroads Heart, Electric Heart, Double Spike, Petal Pendant, Shift, Power Word, Runic, Grecian, Arrowhead, Dog Tags, Hazard Amulet, Icicle, Clover, Hazard Guy, Dragonfly, Hazard Chick, etc.
4) Earrings include: Flower Petal, Fang, Industrial, Hazard Moon, Venom, etc.
5) Rings include: Power Ring, American Indian Ring, Flower Petal Ring, Hazard Ring, Diamond Ring, etc.
6) Wallet includes: Hazard Line Wallet, etc.
7) Belts include: Hazard Line Belt, Snap Belt, etc.
8) Zipper Pulls, 9) Belly Button Piercing, 10) Bookmarks, 11) Bra, 12) Door Hanger, 13) Cell phone/Beeper/Pager Holder, 14) Ipod Case, 15) Cell Phone Charm, 16) Wall Mask, 17) Winter Hat/Beanie Hat, 18) Baseball Cap, 19) Tie, 20) Hoodie, 21) Satchel Bag, 22) Sneaker, 23) Decal Snaps, 24) Money Clip, 25) Magnet, 26) Backpack, 27) Watch Band, 28) Relief Carving, 29) Eyeglass Case, 30) Headband, 31) Coaster, 32) Car Decoration, 33) Ornament, 34) Pet Products, 35) Hair Clip, 36) Change Purse, 37) Purse, 38) Pins/Buttons, 39) Anklet, 40) Lanyard, 41) Nose Piercing, 42) Charms, 43) Button, and 44) Cufflinks.

In addition, there are lists of individual words called “Power Words” and edgy phrases called “Attitudes” are created within this invention, which can be used in these fashion accessories.

In summary, the present invention provides novel, fancy and unique fashion accessories made from traffic cone rubber, which are inexpensive and easy to manufacture. It also satisfies the need of teenagers and young adults for their wearing according to their ages.

### BRIEF DESCRIPTION OF THE DRAWINGS

FIG. 1 presents perspective views of six different styles of Bracelets.

FIG. 2 presents perspective views of eleven different styles of Key Chains.

FIG. 3 presents perspective views of eighteen different styles of Necklace Pendants.

FIG. 4 presents perspective views of five different styles of Earrings.

FIG. 5 presents perspective views of five different styles of Rings.

FIG. 6 presents perspective views of Wallet.

FIG. 7 presents perspective views of two different styles of Belts.

FIG. 8 presents perspective views of Zipper Pulls.

FIG. 9 presents perspective views of Belly Button Piercing.

FIG. 10 presents perspective views of Bookmarks.

FIG. 11 presents perspective views of Bra.

FIG. 12 presents perspective views of Door Hanger.

FIG. 13 presents perspective views of Cell phone/Beeper/Pager Holder.

FIG. 14 presents perspective views of Ipod Case.

FIG. 15 presents perspective views of Cell Phone Charm.

FIG. 16 presents perspective views of Wall Mask.

FIG. 17 presents perspective views of Winter Hat/Beanie Hat.

FIG. 18 presents perspective views of Baseball Cap.

FIG. 19 presents perspective views of Tie.

FIG. 20 presents perspective views of Hoodie.

FIG. 21 presents perspective views of Satchel Bag.

FIG. 22 presents perspective views of Sneaker.

FIG. 23 presents perspective views of Decal Snaps.

FIG. 24 presents perspective views of Money Clip.

FIG. 25 presents perspective views of Magnet.

FIG. 26 presents perspective views of Backpack.

FIG. 27 presents perspective views of Watch Band.

FIG. 28 presents perspective views of two different styles of Relief Carving.

FIG. 29 presents perspective views of Eyeglass Case.

FIG. 30 presents perspective views of Headband.

FIG. 31 presents perspective views of Coaster.

FIG. 32 presents perspective views of Car Decoration.

FIG. 33 presents perspective views of Ornament.

FIG. 34 presents perspective views of two different styles of Pet Products.

FIG. 35 presents perspective views of Hair Clip.

FIG. 36 presents perspective views of Change Purse.

FIG. 37 presents perspective views of Purse.

FIG. 38 presents perspective views of three different styles of Pins/Buttons.

FIG. 39 presents perspective views of two different styles of Anklet.

FIG. 40 presents perspective views of Lanyard.

FIG. 41 presents perspective views of Nose Piercing.

FIG. 42 presents perspective views of Charms.

FIG. 43 presents perspective views of Button.

FIG. 44 presents perspective views of Cufflinks.

### DETAILED DESCRIPTION OF THE PREFERRED EMBODIMENTS

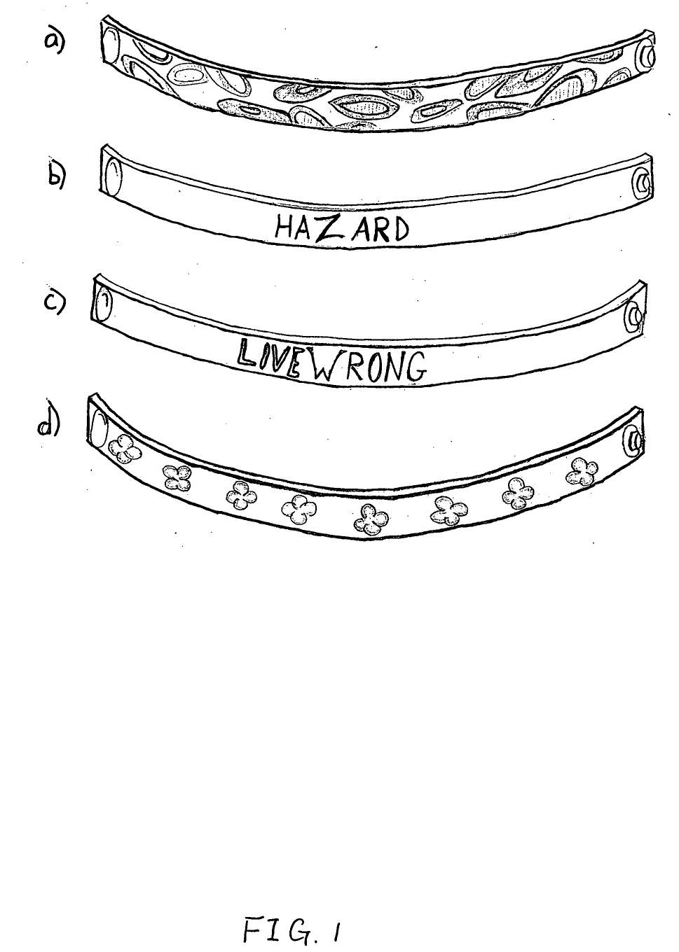

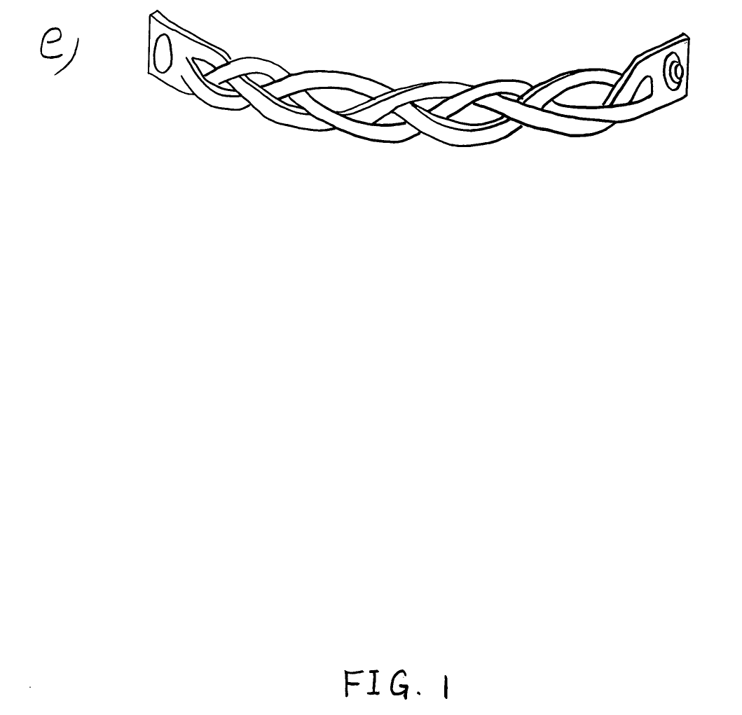

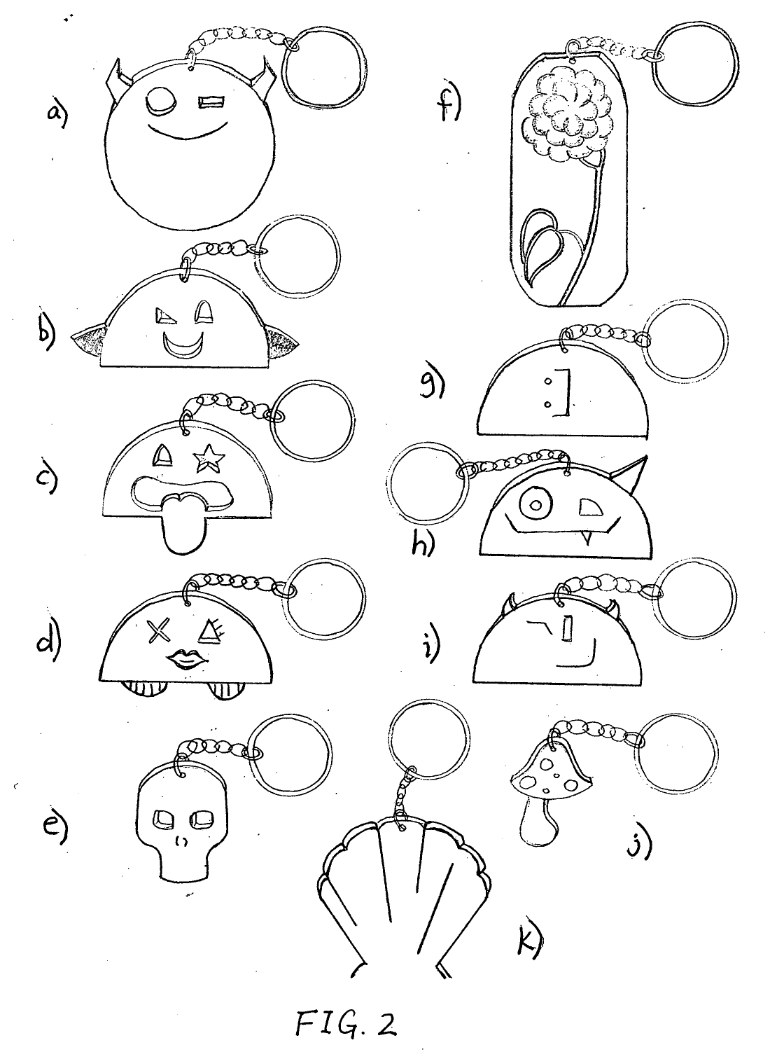

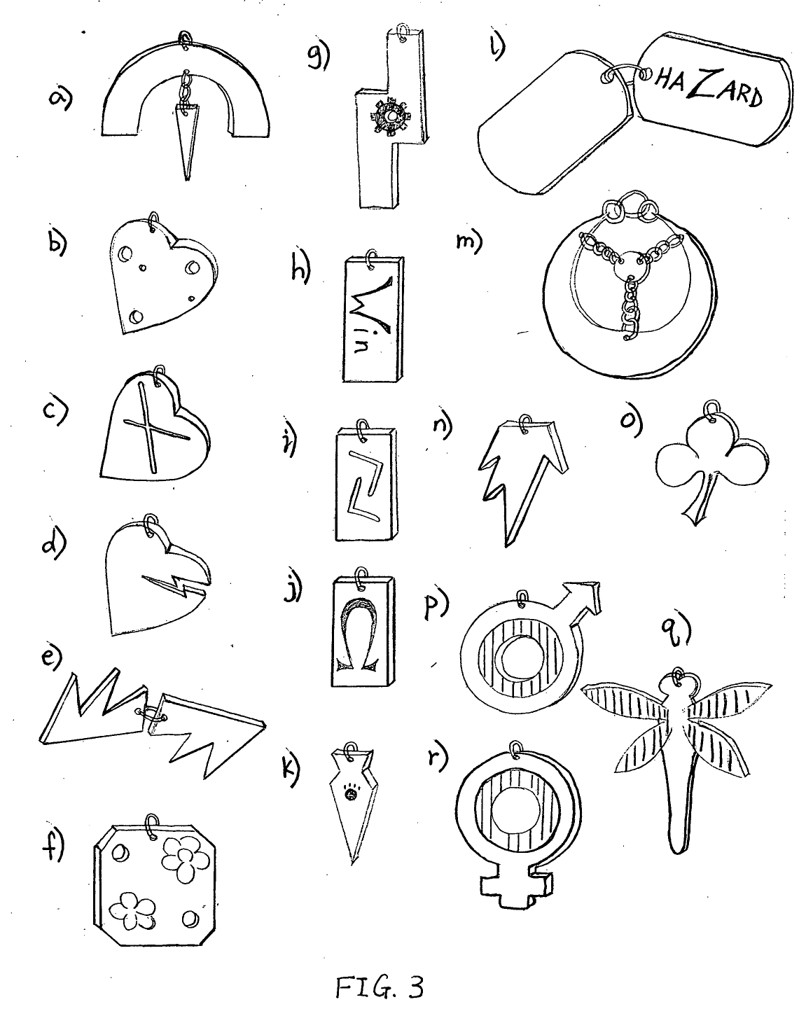

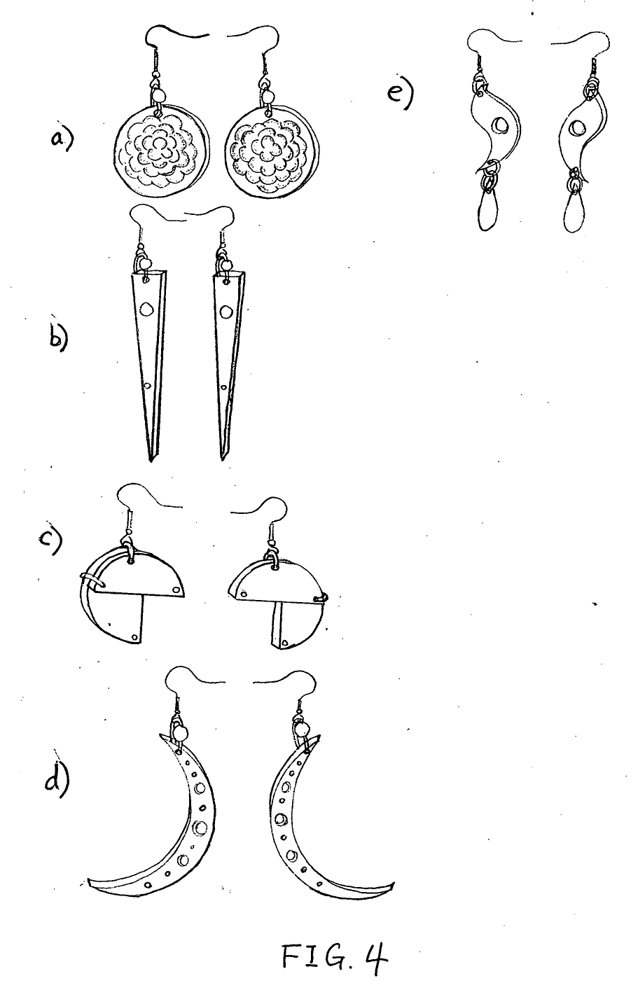

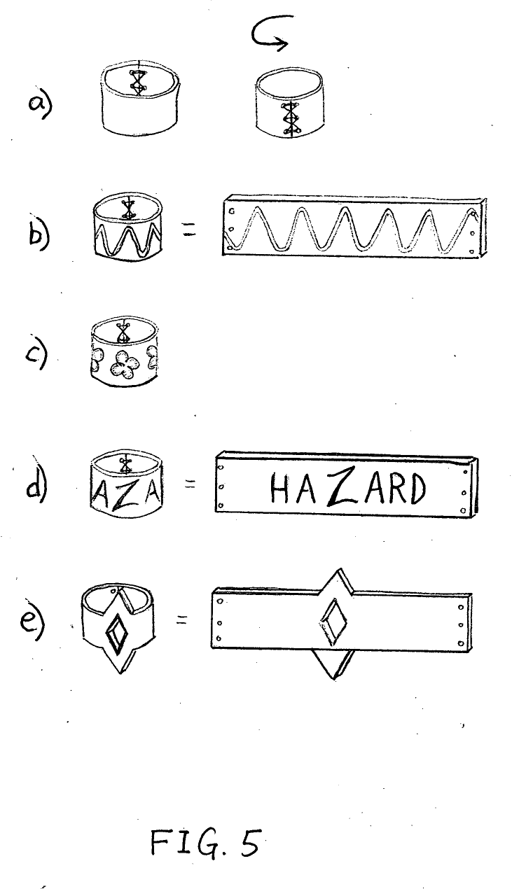

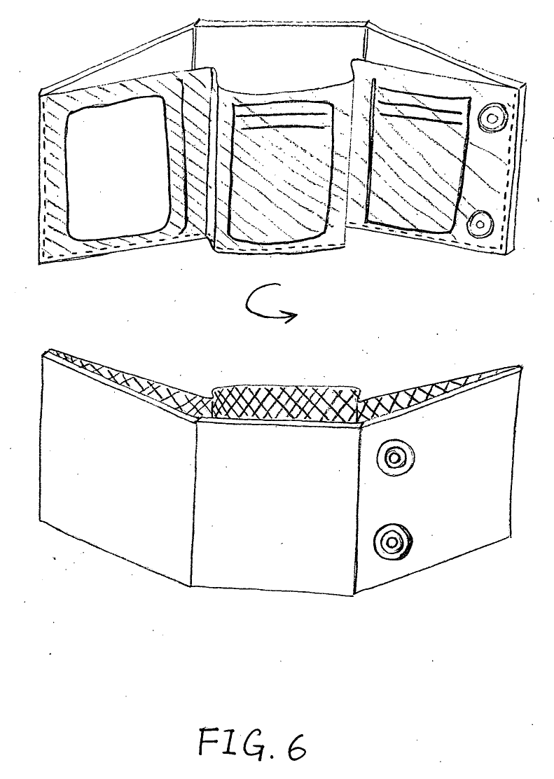

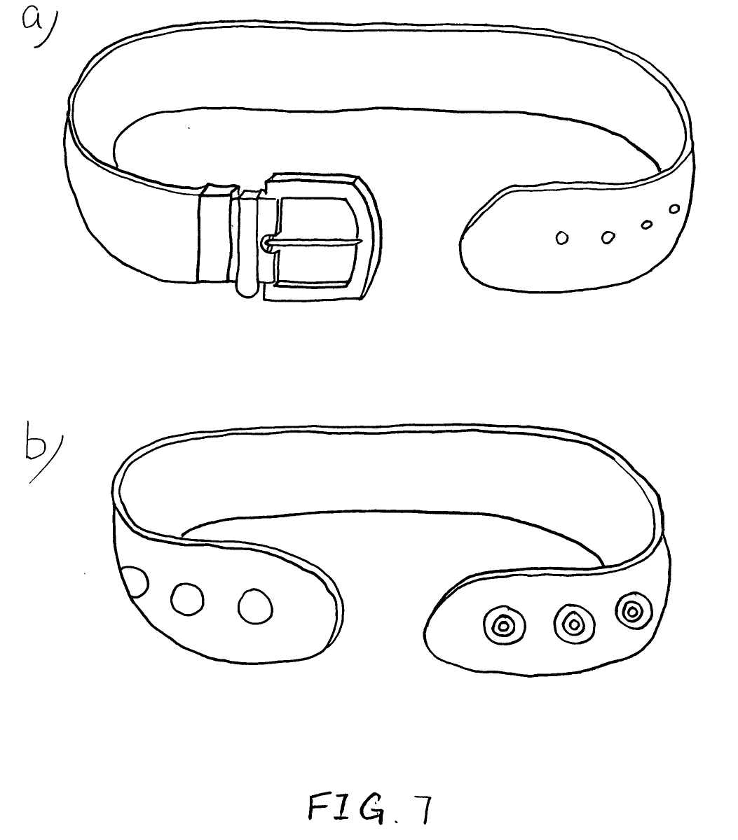

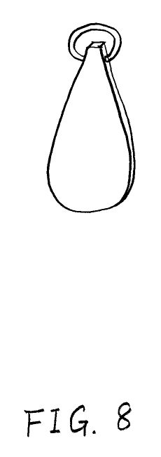

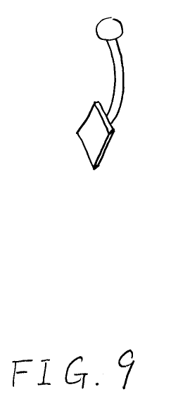

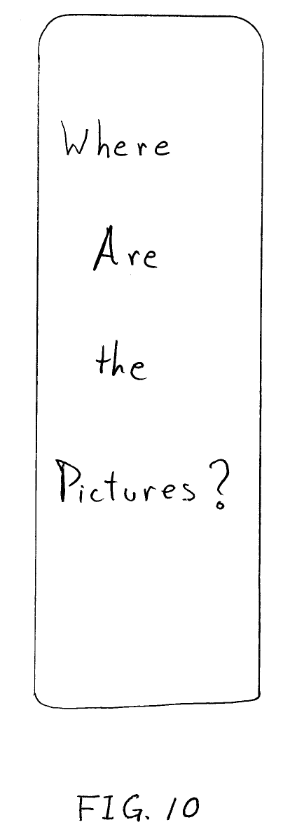

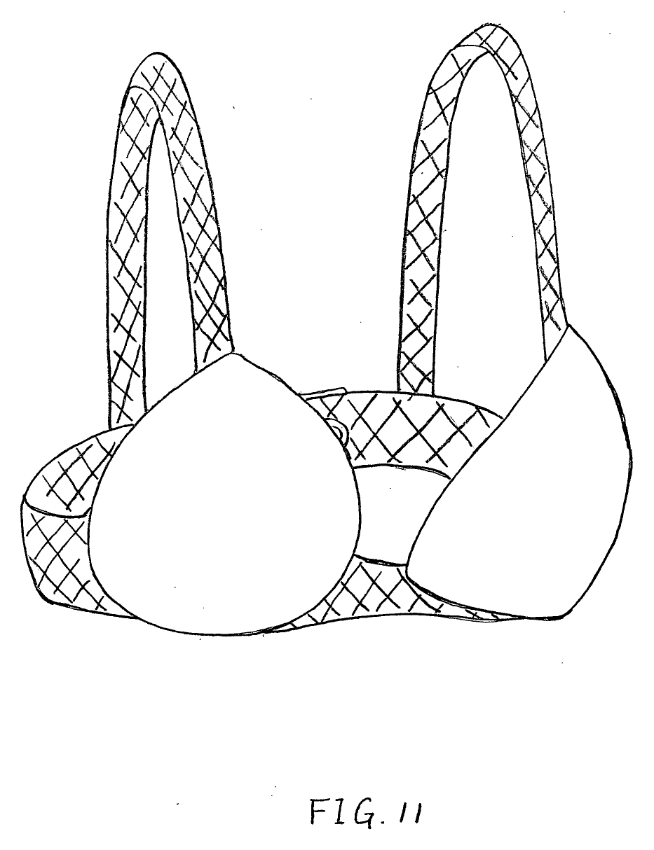

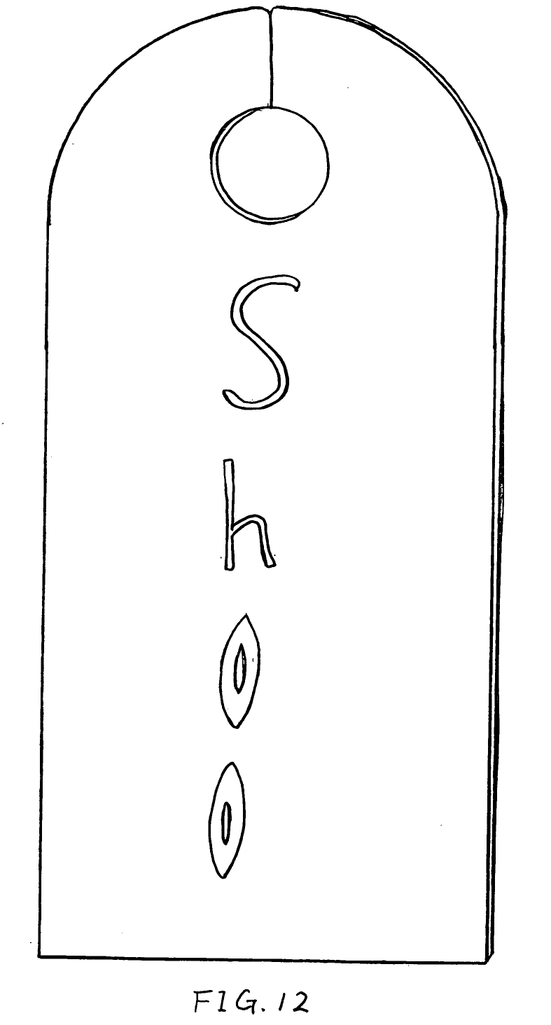

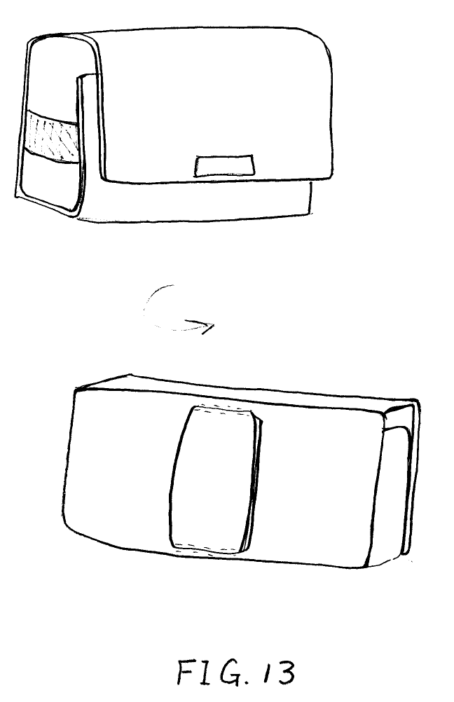

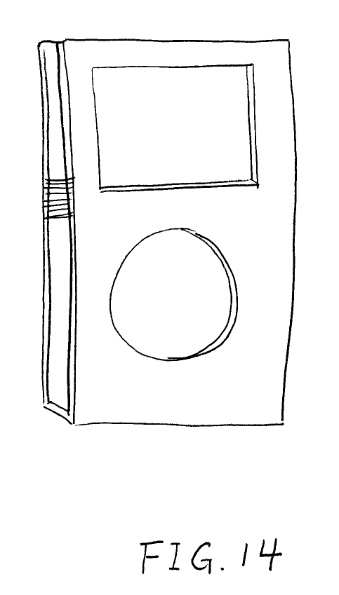

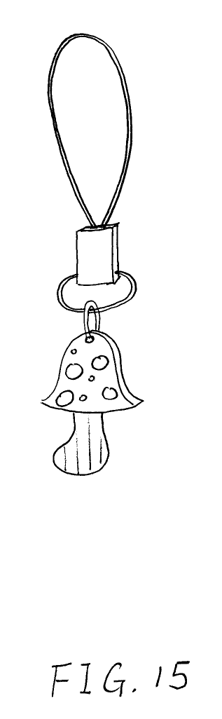

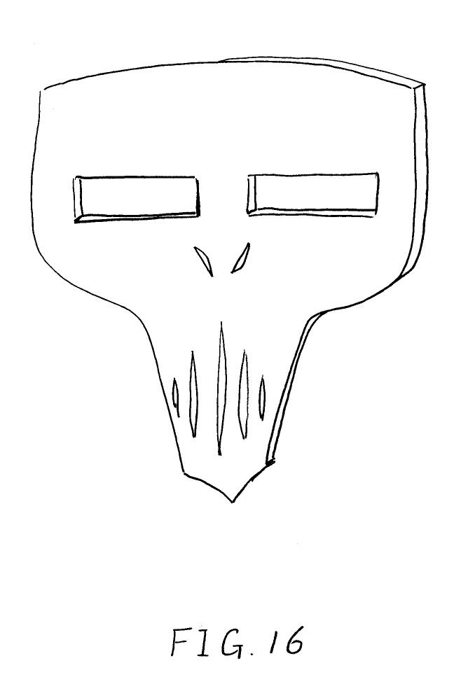

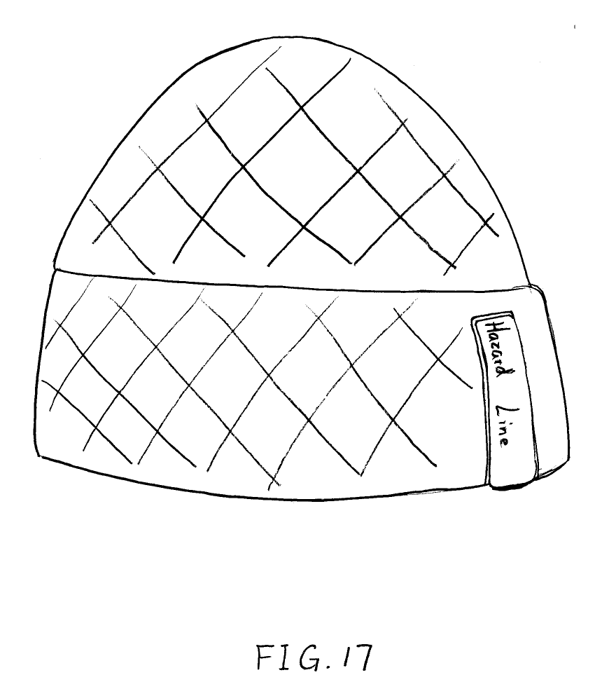

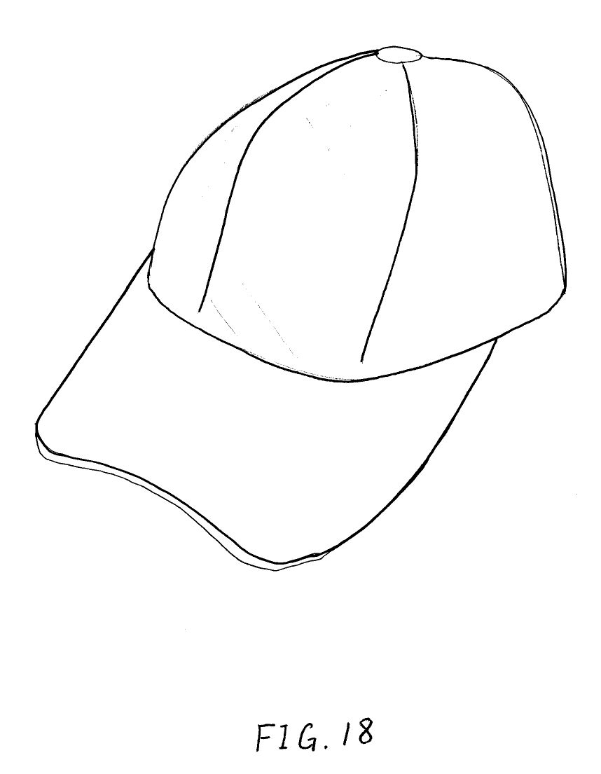

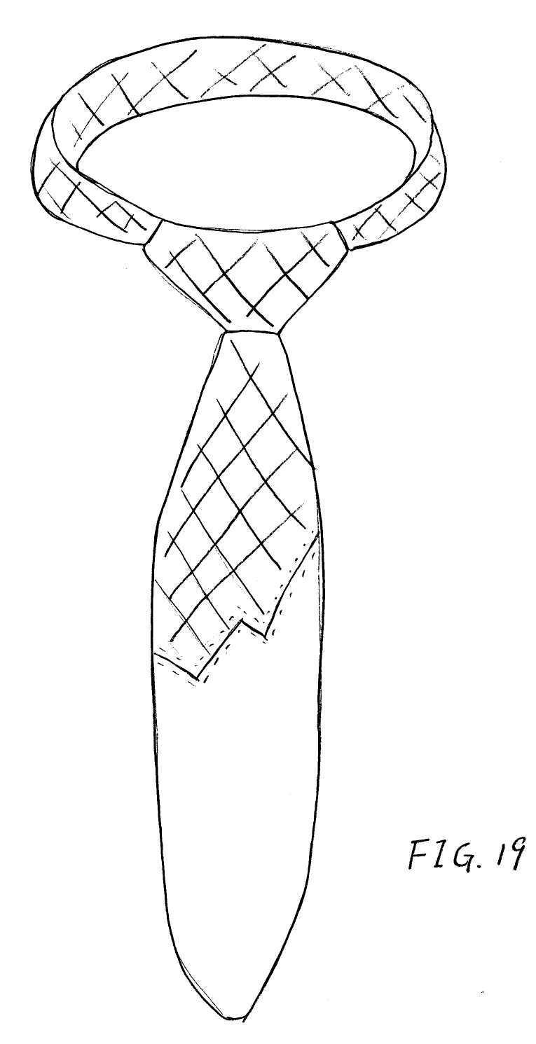

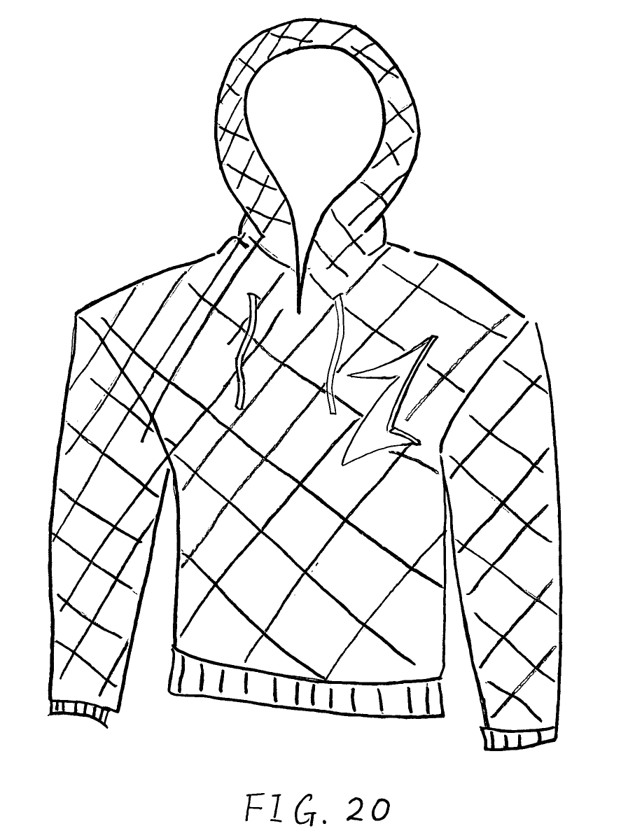

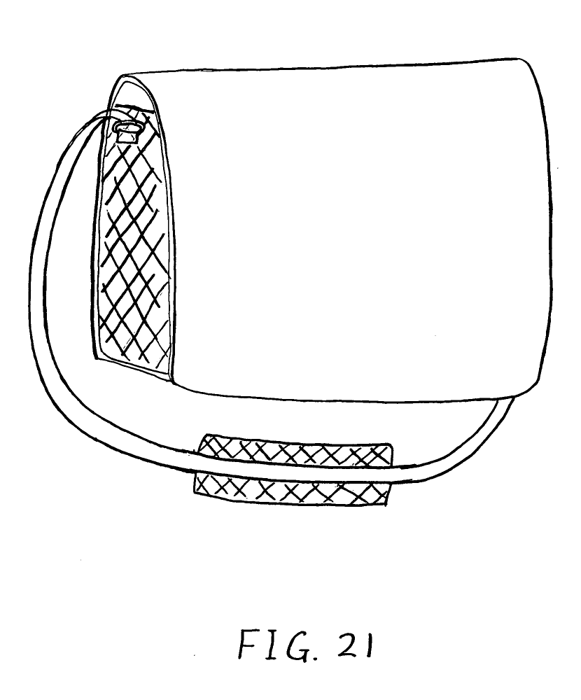

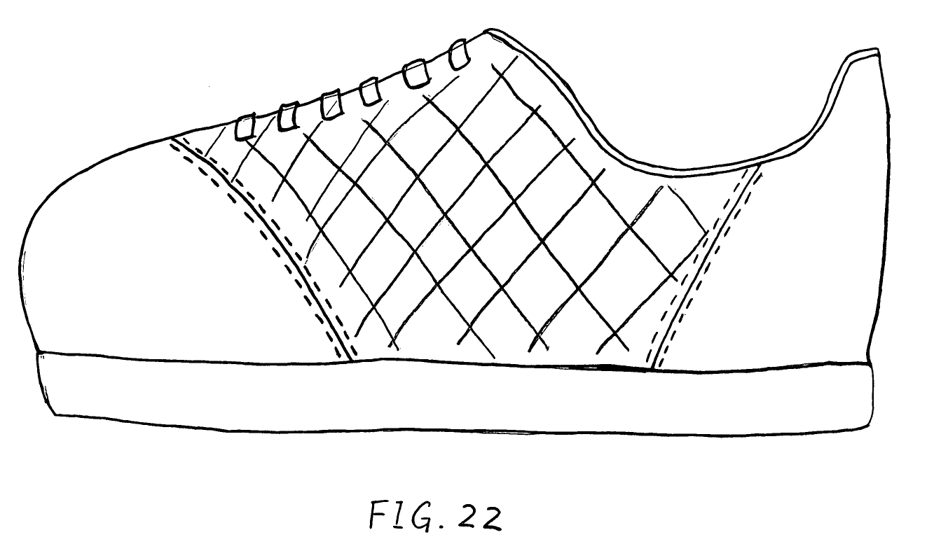

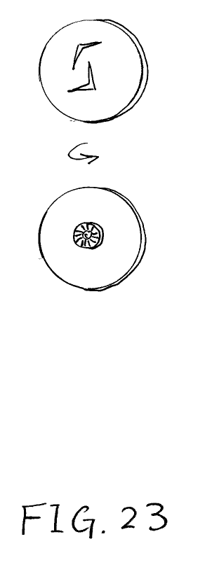

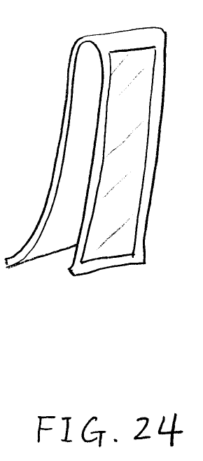

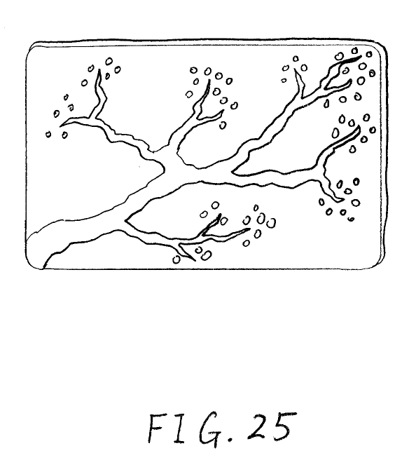

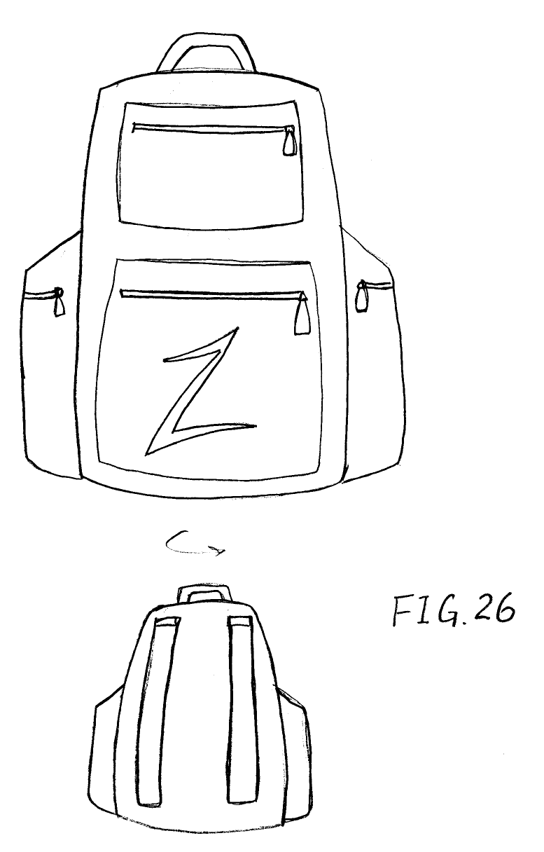

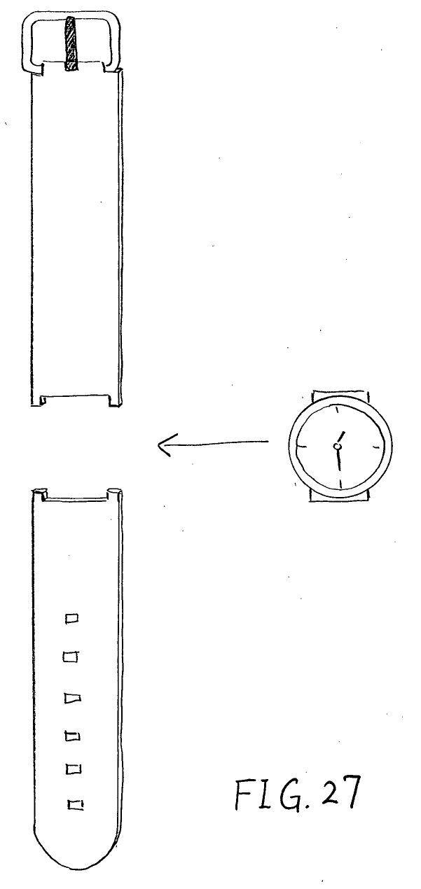

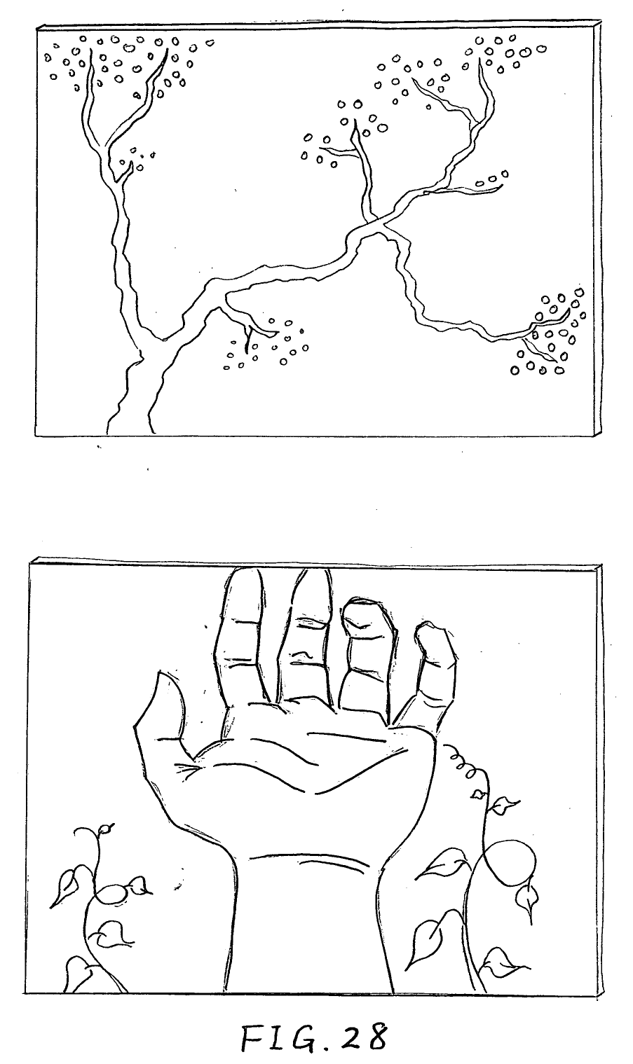

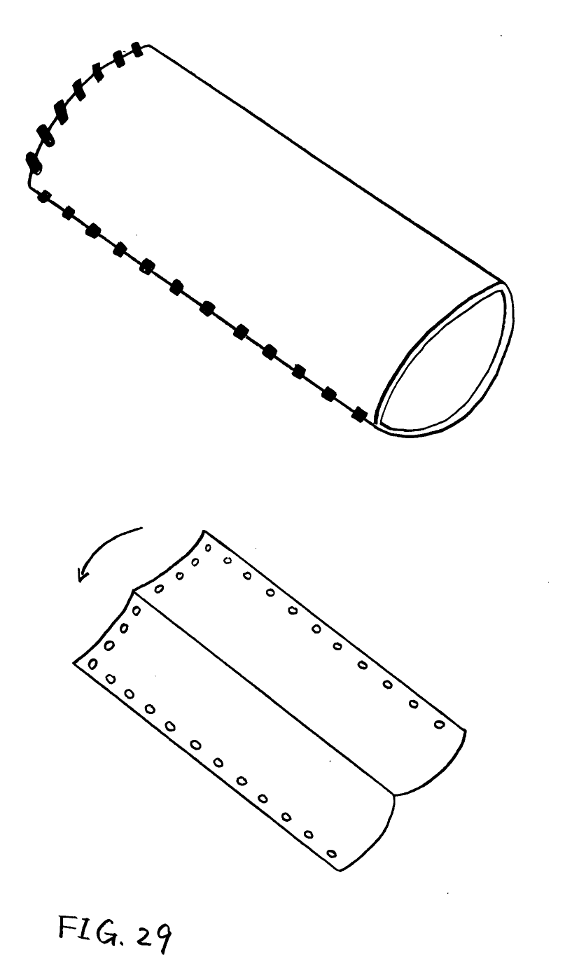

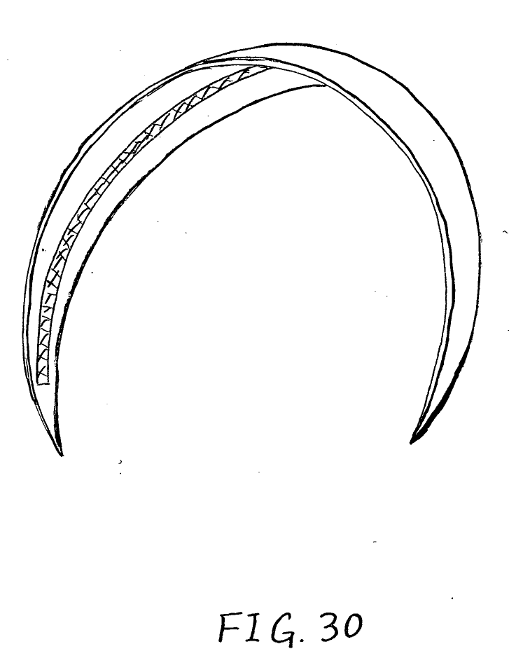

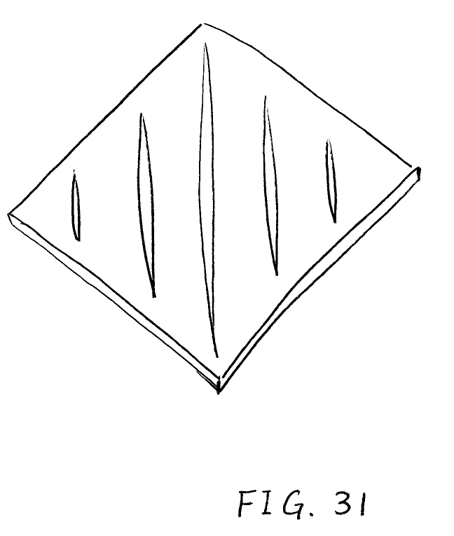

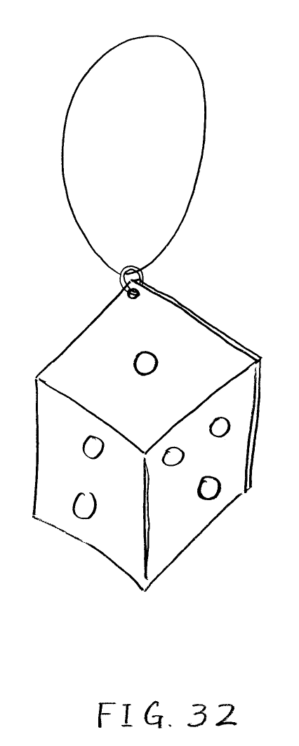

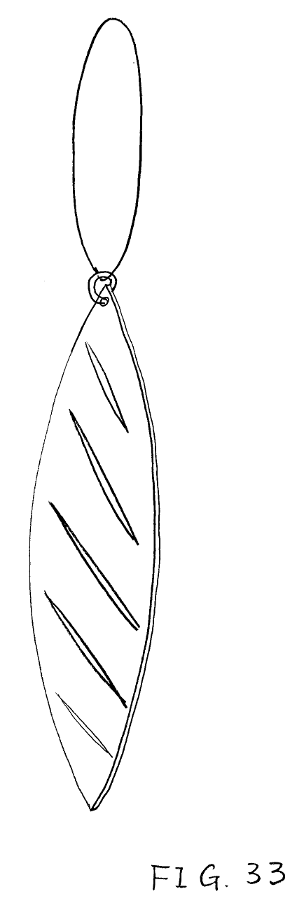

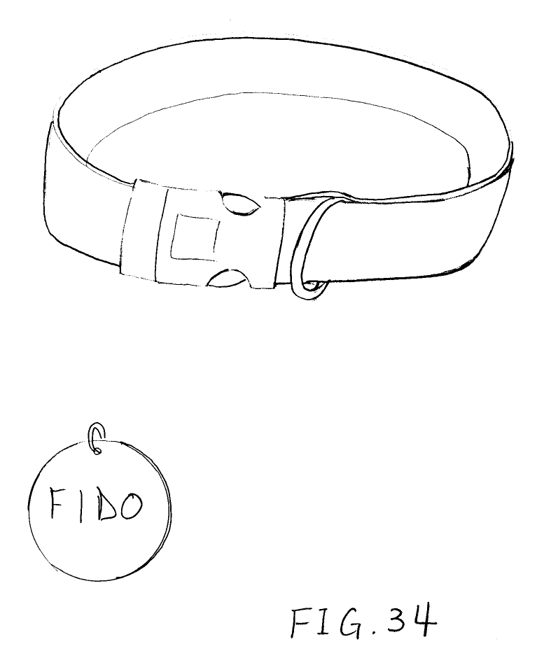

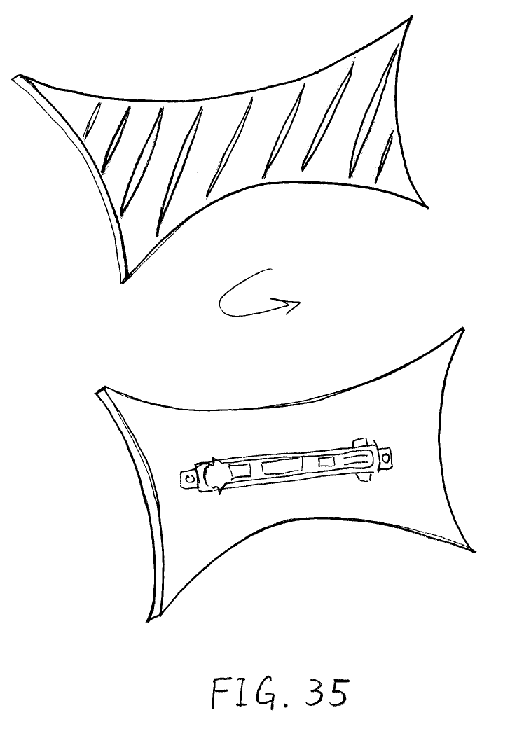

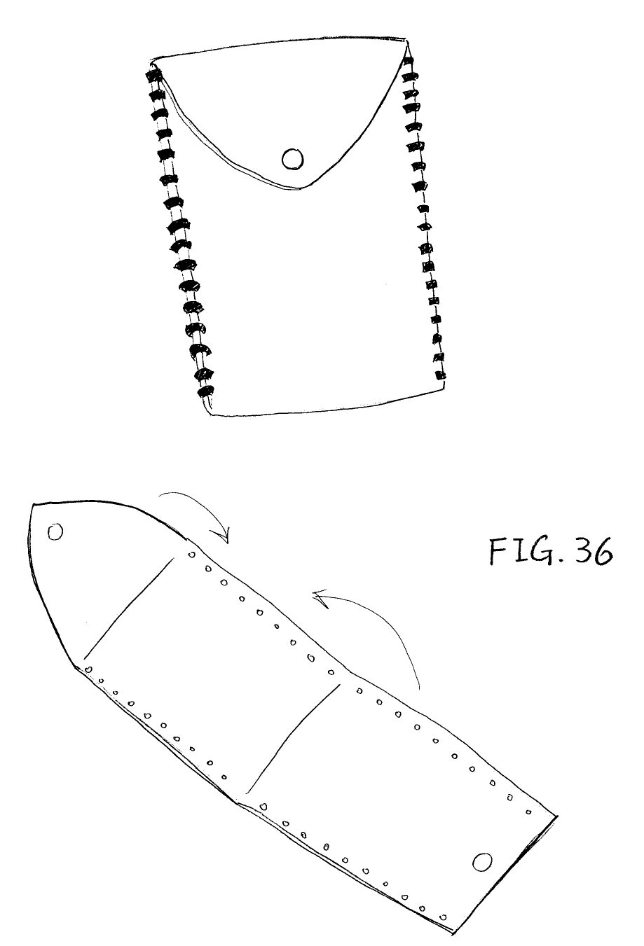

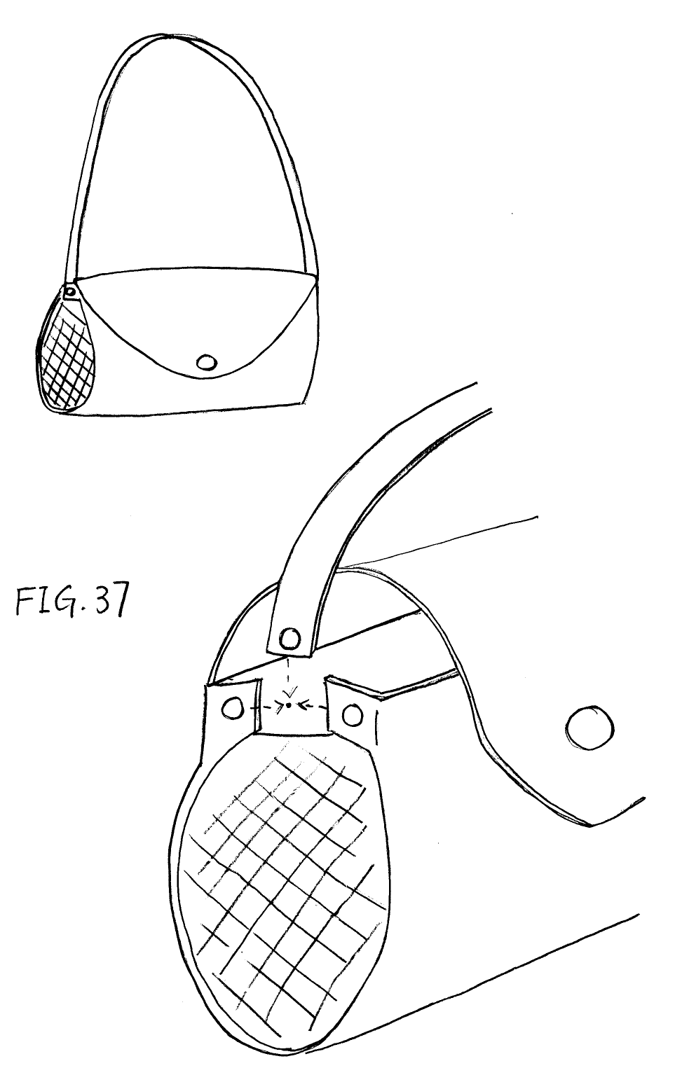

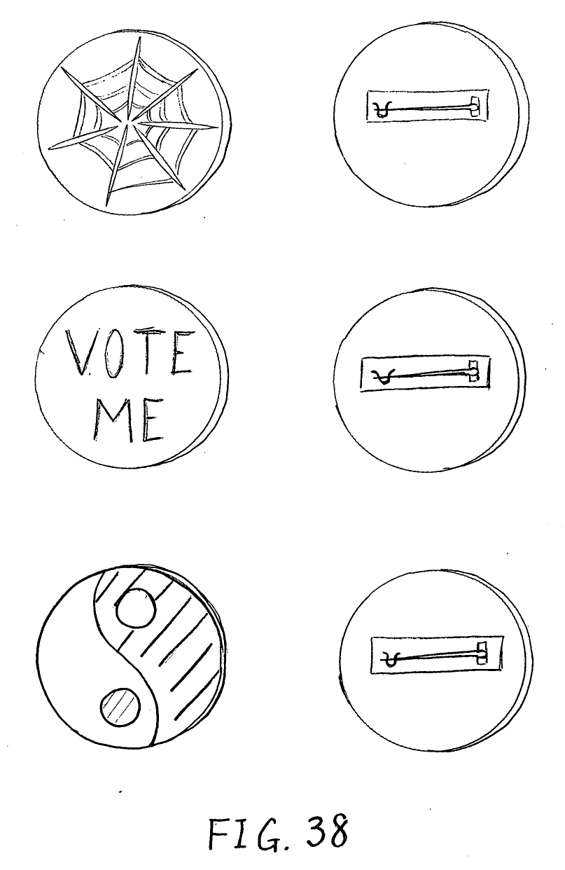

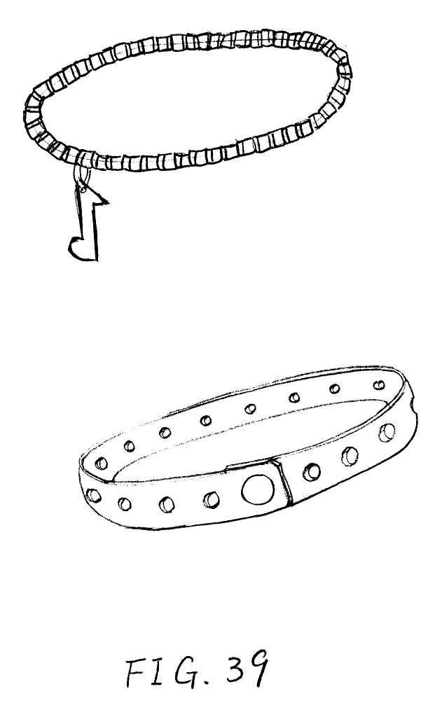

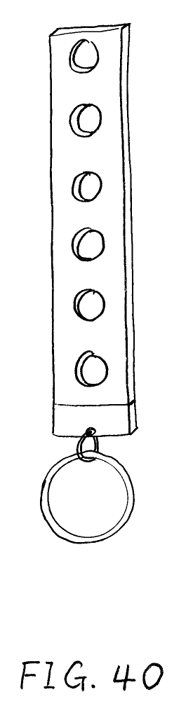

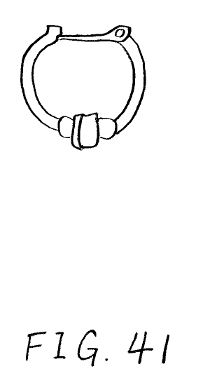

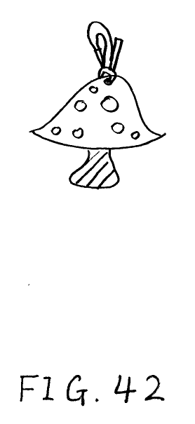

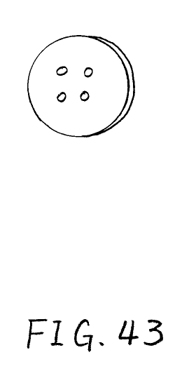

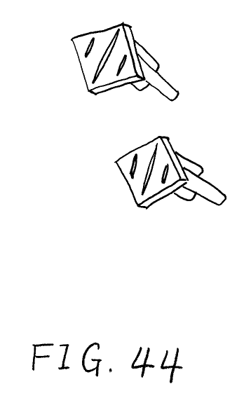

The preferred embodiments may be understood by referring to FIG. 1 to FIG. 44, which depict perspective views of the fashion accessories.

### 1) Bracelets:

### a) Leopard Style:

It is a straight strip of traffic cone material with a female snap on the left end and the male snap unit at the right end. A ‘U-shaped’ chisel is used to gouge out oval-shaped cuts all over the surface of the orange layer of the material. Each gouge digs down to expose a decreasing gradient of the orange layer and exposes the white layer of the material at its deepest point. Each gouge scoops out the material in one smooth “bowl-shaped” motion. The ovals on the provided sketch represent each gouge. The shaded areas represent the decreasing gradient of the orange layer. The vertical line areas represent the deepest spots of each gouge where the white layer is exposed. The width of the bracelet should be about ½ inch and two separate lengths should be designated to fit different wrist sizes—one for men (about 8¼ inch) and a smaller one for women. I believe this piece would appeal to both genders.

### b) Hazard Style:

It is a straight strip of traffic cone material with a female snap on the left end and the male snap unit at the right end. The word “HAZARD” is printed in black on the orange surface in the center. The provided sketch shows that the letter “Z” in the printed word is larger and more stylized than the other letters. Some of the bracelets will have the word “HAZARD” printed in black ink, and some will have it carved into the surface down to the white layer so that it is easily visible. The width of the bracelet should be about ½ inch and two separate lengths should be designated to fit different wrist sizes—one for men (about 8¼ inch) and a smaller one for women. This piece is unisex but may appeal more to the male gender.

### c) Phrase Band Style:

It is a straight strip of traffic cone material with a female snap on the left end and the male snap unit at the right end. This is a bracelet which gives the customer a choice of what he/she wants printed/carved on the orange surface. For example, this piece displays the phrase “LIVEWRONG” with the “LIVE” section carved into the surface down to the white layer, while the “WRONG” section is printed in black ink. The letter “W” should be larger and more stylized than the other letters. However, the customer will have the ability to go onto the company website and choose from a variety of stock phrases to have printed/carved onto the surface of the bracelet. The customer will also have the option of having a custom phrase printed on the bracelet, such as their name or a date of significance to them (provided their entry stays within the space constraint). The width of the bracelet should be about ½ inch and two separate lengths should be designated to fit different wrist sizes—one for men (about 8¼ inch) and a smaller one for women. I believe this piece would appeal to both genders.

### d) Flower Petal Style:

It is a straight strip of traffic cone material with a female snap on the left end and the male snap unit at the right end. Eight small flowers (4 petals each) are carved into the orange surface and evenly spaced along the length of the bracelet. To carve each flower, the edge of a ‘U-shaped’ chisel is inserted just under the surface of the orange layer at a 45-degree angle. While still under the surface, the chisel is arced in a circular motion, cutting a circular shape into the surface of the material. Remove the chisel after about 270-degrees have been carved. No pieces of the material are removed. This makes one petal of a flower. If done correctly, you will have a 270-degree cut of a circle with the uncut 90-degree section oriented in the center. Then rotate the bracelet and repeat the cut 3 more times until you have a flower with 4 petals (with the uncut section in the center). Since the ‘U-shaped’ chisel is inserted at a 45-degree angle, the outer edge of each petal is thinner than the center. This gives the outline of each petal a ‘glowing’ appearance. The width of the bracelet should be about ½ inch and the length should be designated to fit a female wrist. This piece is feminine and would appeal more to the female gender.

### e) Hazard Braid Style:

It is one strip of traffic cone material that has been cut into 3 thin strips in the center (but not at the ends) and has then been intertwined to form a braided appearance, with a female snap on the left end and the male snap unit at the right end. To do this, make 2 evenly spaced cuts along the length of the strip, making 3 even thin strips with even widths (the bottom edges must be beveled smooth before the strips are intertwined and braided). Then intertwine and braid strips according to provided instructions. The width of the bracelet should be about ¾ inch and two separate lengths should be designated to fit different wrist sizes—one for men (about 9 inch) and a smaller one for women. The initial unbraided strip should be 9 inches for men (longer than the previous bracelets) because the bracelet is shorter after being braided. I believe this piece would appeal to both genders.

### f) Stripper Style:

It is one strip of traffic cone material that has been cut into 5 thin strips in the center (but not at the ends), with a female snap on the left end and the male snap unit at the right end. To do this, make 4 evenly spaced cuts along the length of the strip, making 5 even thin strips with even widths (the bottom edges of each thin strip must be beveled smooth). When the customer wears this bracelet, the individual strips will move farther apart and closer together based on the movements of their wrist. The width of the bracelet should be about 1¼ inch and two separate lengths should be designated to fit different wrist sizes—one for men (about 8¼ inch) and a smaller one for women. I believe this piece would appeal to both genders.

Notes: The bottom edges of each bracelet (the edges that rest against the skin) will be sharp from the cutting process and, therefore, must be beveled smooth to prevent skin irritation. The metal snaps should be black.

### 2) Key Chains:

### a) Rebel Head Smirk

It is a circular cutout with a 2-inch diameter. There is a small angular horn on each side of the head. The face is oriented in the top half of the circle. The head's right eye is a large circular hole-punch. Its left eye is a smaller horizontal rectangle cutout. The eyes are relatively close together. A wide, thin smile is printed in black underneath the eyes, stretching the distance from the outer edge of the head's right eye to the outer edge of the head's left. This piece would appeal to both genders. It would probably be more popular with preteens and younger teenagers

### b) Rebel Head Jax

It is a semi-circular cutout with a 2-inch diameter (flat part on bottom). There is a small rounded triangle (colored black) on each side of the head close to the flat bottom of the head. The head's right eye is a small right triangle cutout with the longer leg running parallel to the flat bottom of the head and the hypotenuse facing the round top of the head. The head's left eye is a taller arc-shaped cutout with a flat bottom that runs parallel to the flat bottom of the head. The eyes are relatively close together. The mouth is a crescent shape with the points under each eye. The mouth stretches the distance from the middle of the head's right eye to the middle of its left eye. This piece would appeal to both genders. It would probably be more popular with preteens and younger teenagers.

### c) Rebel Head Blaa

It is a semi-circular cutout with a 2-inch diameter (flat part on bottom). The head's right eye is an arc-shaped cutout with a flat bottom that runs parallel to the flat bottom of the head. The head's left eye is a five-pronged star cutout. The eyes are relatively far apart. The mouth is a large cutout with the right and left extremes being the widest points. The mouth stretches the distance from beyond the outer edge of the head's right eye to beyond the outer edge of the head's left eye. A tongue (both the right and left lobes arching higher than the middle of it) protrudes from the bottom center of the mouth and lolls down over the flat bottom of the head. This piece would appeal to both genders. It would probably be more popular with preteens and younger teenagers.

### d) Rebel Head Lips

It is a semi-circular cutout with a 2-inch diameter (flat part on bottom). There is a pair of small semicircles coming down from the flat bottom of the head (the round part pointing away from the head), one near each corner. The orange layer is shaved off of each small semicircle, so that they are white. The head's right eye is a cutout of an “X”. The head's left eye is an equilateral triangle (pointing up). There are 3 small eyelashes printed in black on the left side of the head's left eye. The eyes are relatively far apart. The mouth is a pair of pouting feminine lips printed in black underneath the eyes. The mouth stretches the distance from the center of the head's right eye to the center of the head's left eye. This piece would appeal to the female gender. It would probably be more popular with preteens and younger teenagers.

### e) Skull

It is the shape of a human skull without the lower jaw and measures 1½ inch from top to bottom. The top of the skull is circular. The sides of the skull come straight down for ⅔ of the way and then curve inward and then down to make the pronounced cheekbones and upper jaw. The bottom of the skull (where the upper teeth would be) ends in an arc facing down. The eye sockets are 2 square-shaped cutouts midway down the length of the skull. The outer corners of each square are wider than the inner corners, giving it more of an eye socket-shape. Underneath the eye sockets, are two small crescent shapes representing the nostrils. They are vertical and their points face each other. They are carved into the surface of the traffic cone material. The other side of the skull will have nostril marks carved in the same area so that on one side, the piece will be an orange skull, and on the other, it will be a white skull. This piece would appeal to both genders.

### f) Flower

It is a rectangular cutout (with rounded edges) with a flower, stem, and leaf carved into the surface. The rectangle measures 3 inches from top to bottom and 1½ inches from side to side. The top half of the rectangle is devoted to the flower head. To carve each flower, the edge of a ‘U-shaped’ chisel is inserted just under the surface of the orange layer at a 45-degree angle. While still under the surface, the chisel is arced in a circular motion, cutting a circular shape into the surface of the material. Remove the chisel after about 270-degrees have been carved. No pieces of the material are removed. This makes one petal of a flower. If done correctly, you will have a 270-degree cut of a circle with the uncut 90-degree section oriented in the center. Then rotate the key chain and repeat the cut until you have a flower with about 20-23 petals (with the uncut section in the center). Since the ‘U-shaped’ chisel is inserted at a 45-degree angle, the outer edge of each petal is thinner than the center. This gives the outline of each petal a ‘glowing’ appearance. Then a curved stem is carved from the bottom right of the flower to the bottom center of the rectangle. A curved leaf is carved to the left of the stem with a curved connecting line. This piece would appeal to the female gender.

### g) Rebel Head Texty

It is a semi-circular cutout with a 2-inch diameter (flat part on bottom). In the center of the semicircle, two small holes are punched out forming a colon. Very close to the colon on the right side is a large closed bracket painted in black. The face should look like this, “:]”. This piece would appeal to both genders.

### h) Rebel Head Punchy

It is a semi-circular cutout with a 2-inch diameter (flat part on bottom). A triangle protrudes from the head's upper left side. The head's right eye is a small hole-punch with a larger circle printed around it. The head's left eye is a cutout of a quarter-circle (the arc pointing in the same direction of the triangle. The eyes are relatively far apart. The mouth is a broad straight line that runs parallel to the head's flat bottom until it reaches the outer edges of each eye where it angles upwards and out. A small triangular tooth points down from the mouth, under the head's left eye. The mouth and tooth are printed in black. This piece would appeal to both genders. It would probably be more popular with preteens and younger teenagers.

### i) Rebel Head Winks

It is a semi-circular cutout with a 2-inch diameter (flat part on bottom). A pair of small curved horns protrudes from the upper portion of the head, one on each side. The head's right eye is a horizontal line that then angles down at the inner edge, representing a wink. It is printed in black. The head's right eye is a vertical cutout of a rectangle. The eyes are relatively close together. The mouth is a thin line that starts under the head's left eye, runs to the head's left, and then makes a 90-degree curve upwards. This piece would appeal to both genders. It would probably be more popular with preteens and younger teenagers.

### j) Mushroom

It is the shape of a mushroom with a curved stem and measures about 2 inches in height. The head of the mushroom is a bell shape with the highest point in the upper center. The bottom edge of the mushroom head is an arc that points down. Along the mushroom head's right side are two large hole-punches. In the center are two small hole punches in the same orientation as the bigger holes. Then there is one big hole punch at the mushroom head's lower left corner. A curved stem comes down from the mushroom head on the right side. The stem has a wide bulbous base and a thinner neck. The base is skewed more towards the center. The orange layer is shaved off of the stem, making it white. This piece would appeal to both genders.

### k) Sea Shell

It is the shape of a scallop shell measuring 2 inches from top to bottom and 2 inches from side to side. The shell consists of 7 humps that are widest at the top and taper down as they run towards the bottom of the piece. The middle hump is the largest, while the humps get smaller as they approach the left and right extremes. Grooves are carved in straight lines from both low points on the main hump down towards the bottom of the shell in a converging manner (although they do not converge). The line on the left side of the main hump runs ⅔ down the length of the shell. The line on the right side of the main hump is shorter and runs only ½ way down the shell. The first hump to the right of the main hump has a line that runs down, but in the center only. It does not touch the top or bottom edge. The third hump to the left of the shell has a line that runs ½ way down the shell. Just before the bottom of the shell, it angles out and downward to form a base. This piece is unisex but I believe that it would appeal more to the female gender.

Notes: The top center of each piece will have a small hole punched through it so that a jump ring can connect it to the metal key chain unit.

### 3) Necklace Pendants:

### a) Sunrise

It is a semicircular arc (2 inch diameter) in the shape of a rainbow with a skinny triangle hanging down from the center. The body of the arc is about ½ an inch in thickness. There is a small hole punch at the vertex of the inner arc edge. Here, 3 jump rings are linked together and to an upside down skinny triangle about 1 inch in height. Although this piece is unisex, it will probably be more appealing to the female gender.

### b) Bubble Heart

It is a cutout of a heart-shape with holes punches through it (the top hole and jump ring are located on the top of the heart's right lobe, making the pendant hang at a stylish angle on a chain). At its widest part, the heart measures about 1½ inches and about 1½ from the top of each lobe to the bottom point. Along the middle edge of the heart's right lobe is a large hole punch. Over to the left about a centimeter is a small hole punch. There is a large hole punch close to the top of the heart's left lobe. There is a small hole punch along the middle edge of the heart's left lobe. A large hole punch is located just above the point at the bottom of the heart. Not counting the hole required for the jump ring at the top, there are 5 holes. This piece is feminine and would appeal more to the female gender.

### c) Crossroads Heart

It is a cutout of a heart-shape with an off-center ‘X’ carved on the surface (the top hole and jump ring are located on the top of the heart's right lobe, making the pendant hang at a stylish angle on a chain). At its widest part, the heart measures about 1½ inches and about 1½ from the top of each lobe to the bottom point. Two straight lines are carved into the surface of the heart (down to the white layer) and intersect just inside the heart's right lobe. The ends of the lines are contained within the heart and do not touch the edges. The bottom leg of the line that points to the heart's left is shorter than the other line's bottom leg. This piece is feminine and would appeal more to the female gender.

### d) Electric Heart

It is a cutout of a heart-shape with a lightning bolt cut out coming from the heart's upper left lobe (the top hole and jump ring are located on the top of the heart's right lobe, making the pendant hang at a stylish angle on a chain). At its widest part, the heart measures about 1½ inches and about 1½ from the top of each lobe to the bottom point. A lightning bolt cutout originates from the heart's upper left lobe (the lightning bolt's widest point). The bolt slants diagonally downward (towards the heart's right) for about a centimeter, angles downward to the left for about a ½ centimeter, and then angles downward to the right for another centimeter before coming to a point at the heart's line of symmetry. This piece is feminine and would appeal more to the female gender.

### e) Double Spike

This pendant consists of 2 identical cutouts linked by the same jump ring. The shape resembles a stylized “L” shape with a spike at the inner crux. The entire shape is angular with no curves. The top of the shape (where the small hole and jump ring are placed) is flat and measures about 1½ centimeter. This forms a right angle with another side, which measures about 3½ centimeters. We shall call this piece's right side. From here, the shape angles upward to its left for about 2½ centimeters, then angles back towards the piece's right side at a perpendicular angle to it (forming the first spike). Another spike emerges from this point, resembling the first spike. From this point, the piece angles upward and to its left to touch the top line to complete the shape. Two identical pieces are put on one jump ring at opposite orientations so that one piece displays its orange side while the other displays its white side. This piece is unisex and would appeal to bother genders.

### f) Petal Pendant

It is a 1½-inch square (with the angles cut off) with 2 large hole punches and 2 flowers carved into the surface. The top small hole and jump ring are place at the top center of one of the sides. The piece's top left and bottom right corners have a flower carved at each location. To carve each flower the edge of a ‘U-shaped’ chisel is inserted just under the surface of the orange layer at a 45-degree angle. While still under the surface, the chisel is arced in a circular motion, cutting a circular shape into the surface of the material. Remove the chisel after about 270-degrees has been carved. No pieces of the material are removed. This makes one petal of a flower. If done correctly, you will have a 270-degree cut of a circle with the uncut 90-degree section oriented in the center. Then rotate the pendant and repeat the cut until you have a flower with 5 petals (with the uncut section in the center). Since the ‘U-shaped’ chisel is inserted at a 45-degree angle, the outer edge of each petal is thinner than the center. This gives the outline of each petal a ‘glowing’ appearance. The piece's top right and lower left corners have a large hole-punch at each location. This piece is feminine and would appeal more to the female gender.

### g) Shift

It is a piece that looks like two vertical rectangles placed side by side (each measuring 1½ inches in height and slightly less than ½ an inch from side to side) that are fused after one was shifted slightly up (although it is one piece of material). The lower half of the left rectangle's right side is “fused” to the upper half of the right rectangle's left side. A circular gear is printed in black in the center of the pendant. The middle of the gear is a large hole-punch. This piece is unisex and would appeal to both genders.

### h) Power Word

It is a vertical rectangular strip measuring 1½ inch in height and ¾ of an inch from side to side. This kind of pendant will give the customer a variety of power-inspiring/edgy words to choose from that are printed/carved into the surface of the material. For instance, the provided drawing portrays the word “Win” printed in black on the surface of the material. Some other Power Word pendants that are available read: “Pump”, “Rebel”, “Luck”, and many others. This piece is unisex and would appeal to both genders.

### i) Runic

It is a vertical rectangular strip measuring 1½ inch in height and % of an inch from side to side. This kind of pendant will give the customer a variety of Runes (supposedly magical symbols from an ancient alphabet) to choose from that are printed/carved into the surface of the material. For instance, the provided drawing portrays the Rune called ‘Jera’ carved into the surface of the material. The name of the Rune is printed in small letters on the other side of the pendant. The other Runic pendants will exhibit other Runes of the Runic alphabet. This piece is unisex and would appeal to both genders.

### j) Grecian

It is a vertical rectangular strip measuring 1½ inch in height and ¾ of an inch from side to side. This kind of pendant will give the customer a variety of Greek letters to choose from that are printed/carved into the surface of the material. For instance, the provided drawing portrays the letter ‘Omega’ printed in black onto the surface of the material. The name of the Greek letter is printed in small letters on the other side of the pendant. The other Grecian pendants will exhibit other Greek letters of the Greek alphabet. This piece is unisex and would appeal to both genders.

### k) Arrowhead

It is the shape of an arrowhead pointing downward, measuring about 1½ inch in height. The pendant is angular and has no curves. There is a circle with 4 small vertical lines around the top half of the circle printed in black. This represents a bear paw print. This piece is unisex and would appeal to both genders.

### l) Dog Tags

Two identical cutouts of standard size dog tags are joined by one jump ring at the top of each cutout (the hole punch at the top of each dog tag for the jump ring should be large, and the jump ring should have a ½ inch diameter). Both dog tags are oriented in the same direction, meaning that both orange sides are visible. The word “HAZARD” is printed on one of the dog tags on the orange side. As shown in the provided drawing, the letter “Z” is larger and more stylized than the other letters. The other dog tag is blank and gives the customer the opportunity to customize it through the company website. The customer will have the option of having their name, blood type, or date of significance printed on the dog tag. The customer will also have the option of choosing from a list of power words or graphics to have printed in black on the dog tag. The dog tags must be sold with the metal-ball chain that dog tags are customarily worn on. This piece is unisex and would appeal to both genders.

### m) Hazard Amulet

This pendant is an extreme crescent shape with a small circle of traffic cone material in the center space, held in place by 3 thin taught chains. The extreme crescent shape measures 2 inches in diameter. It is almost a complete circle, except for the 1-centimeter distance between the two end points. The widest part of the crescent is the bottom (opposite the 2 end points). A set of 3-linked jump rings is placed from the left end point to the right end point. The chain threads through the middle of these rings. A small circle of traffic cone material (measuring 1 centimeter in diameter) hangs in the center of the space of the crescent by 3 thin taught chains. Three small holes are punched on the inner edge of the crescent curve in an upside down equilateral triangle formation. A similar formation of holes is punched on the outer edges of the small inner circle. A chain anchors each of the corresponding holes, suspending the small circle in the center of the space. This piece is unisex but would probably appeal more to the female gender.

### n) Icicle

This pendant has a flat top from which 4 spikes hang down. It resembles an upside down isosceles triangle with 3 spikes coming off of it. The flat top measures about ½ an inch. From the top, the piece angles down and to its left for ½ an inch and then angles up and to its right to form the first small spike (the other end of the pendant mirrors this). Then the piece angles down for about 1 inch, then angles up and to its right for about ¾ of an inch to make the main spike. From here the piece angles down and away from the main spike for about ¼ of an inch and then back up for a ½ inch to form the third spike. This last line meets the fourth spike that was the mirror image of the first spike. This piece is unisex and would appeal to both genders.

### o) Clover

This pendant is in the shape of a 3-leaf clover measuring 1½ inch in height and 1 inch from side to side. The stem of the clover is curved to the pendant's left. This piece is unisex and would appeal to both genders.

### p) Hazard Guy

This pendant is in the classic shape of the ‘male symbol’. It is a circular cutout with a diameter of 1½ inches and the short, thick arrow protruding from the pendant's upper left. From the outer edge of the circle curve, ¼ inch of the diameter is the orange layer. Then the next ¼ inch is shaved down to the white layer (shown by the vertical lines in the accompanying drawing), giving the appearance of a smaller white circle within a larger orange circle. Then from the white layer to the center is a big hole punch measuring ½ an inch in diameter. The arrow measures ½ inch from the edge of the circle curve. This pendant is the masculine symbol and would appeal to the male gender.

### q) Dragonfly

This pendant is in the shape of a dragonfly with 4 wings. The pendant measures about 2¼ inches in height, 2¼ inches between the tips of the top two wing tips, and 1½ inch between the two bottom wing tips. The head of the dragonfly is the shape of 2 conjoined circles. Its upper wings are longer than its lower wings. The pendant's upper wings point diagonally upward and away from the body. Its lower wings point diagonally downward and away from the body. The wings are oblong and come to a point. The orange layer on the wings is shaved down to the white layer (shown by the vertical lines in the accompanying drawing), making the wings white. This piece is unisex but would probably appeal more to the female gender.

### r) Hazard Chick

This pendant is the classic shape of the ‘female symbol’. It is a circular cutout with a diameter of 1½ inches and a short, thick cross protruding from the bottom. From the outer edge of the circle curve, ¼ inch of the diameter is the orange layer. Then the next ¼ inch is shaved down to the white layer (shown by the vertical lines in the accompanying drawing), giving the appearance of a smaller white circle within a larger orange circle. Then from the white layer to the center is a big hole punch measuring ½ an inch in diameter. The cross measures ½ inch from the edge of the circle curve.

Notes: Each individual piece has a small hole punch at the top allowing a jump ring to connect it to a chain.

### 4) Earrings:

### a) Flower Petal Style Earrings

This earring is a circular cutout measuring about 1 inch in diameter. A flower is carved into the orange surface. To carve each flower the edge of a ‘U-shaped’ chisel is inserted just under the surface of the orange layer at a 45-degree angle. While still under the surface, the chisel is arced in a circular motion, cutting a circular shape into the surface of the material. Remove the chisel after about 270-degrees has been carved. No pieces of the material are removed. This makes one petal of a flower. If done correctly, you will have a 270-degree cut of a circle with the uncut 90-degree section oriented in the center. Then rotate the earring and repeat the cut until you have a flower with about 25 petals (with the uncut section in the center). Since the ‘U-shaped’ chisel is inserted at a 45-degree angle, the outer edge of each petal is thinner than the center. This gives the outline of each petal a ‘glowing’ appearance. A small hole is punched at the outer edge of the earring to house the jump ring that connects the hook. On the jump ring is a small light blue bead. The product can be produced with other color beads as well. This is a feminine product and would appeal to the female gender.

### b) Fang Style Earrings

This earring is a long skinny, upside down isosceles triangle. The triangle measures 2¼ inches in height and ¼ inch from side to side at the flat top. There is a large hole punch in the center of the triangle ½ inch down from the flat top. There is a small hole punch in the center of the triangle 1¼ inches down from the flat top. A small hole punch is located at the top edge of the triangle to house the jump ring that connects the hook. On the jump ring is a small yellow bead. The product can be produced with other color beads as well. This is a feminine product and would appeal to the female gender.

### c) Industrial Style Earrings

This earring is a combination of 2 semicircles held together by 2 jump rings running through corresponding small hole punches. Each identical semicircle has a diameter of 1 inch. Each has 3 small hole punches: one at the bottom left corner, one at the top center of the curved edge, and one at the bottom right corner. One semicircle is oriented so that its flat side is facing right. The other semicircle is oriented so that its flat side faces down, and is then placed over the top of the first semicircle so that 2 of the holes line up. The bottom semicircle's top corner hole lines up with the top semicircle's middle curve hole, while the bottom semicircle's middle curve hole lines up with the top semicircle's left corner hole. 90-degrees of the two semi-circles should line up. Jump rings are locked through the lined up holes. Both orange sides should be showing. The hook is attached to the top jump ring. This is a feminine product and would appeal to the female gender.

### d) Hazard Moon Style Earrings

This earring is a ½ circle crescent shape with a 2-inch diameter. The widest point of the moon is the center and measures 1 centimeter from side to side. There is a large hole-punch in the center of the moon. Following the curve of the moon under the middle hole, are evenly spaced hole punches: 1 small, 1 large, 2 small. This hole-pattern is mirrored along the curve of the moon above the middle hole as well. Another small hole is punched at the top corner of the moon to house the jump ring that connects the hook. On the jump ring is a small pearl bead. The hook must be oriented on the earring so that the orange surface shows and the points of the crescent point forward when worn by the customer. This is a feminine product and would appeal to the female gender.

### e) Venom Style Earrings

This earring is a curved shape that comes to a sharp point from which hangs a smaller teardrop shape. The main piece measures 1 inch in height and about ½ an inch at its widest part in the center from side to side. The main piece's left curve comes down from a point and then resembles the outer edge of a semicircle. The piece's right curve bows out at first, then bows in, and then curves to meet the left curve at a skewed point. There is a large hole-punch in the center of the main piece. There is a small hole-punch at both endpoints. The side that resembles the outer edge of a semicircle is the back of the earring. The small hole at the bottom of the piece is linked with 2 small jump rings, which are connected to a small hole at the point of the teardrop shape. The teardrop shape measures ¾ of an inch in height. The small hole at the top of the main piece houses the jump ring that connects to the hook. If oriented correctly, the orange side will show when worn by the customer and the bottom point will point forward. The earring is meant to symbolize the tip of a scorpion's tail with a drop of venom coming out of the point. This is a feminine product and would appeal to the female gender.

Note: One earring is described in detail. The accompanying earring for each pair is the mirror image of the one described. Each earring has a standard hook attached to the jump ring at the top of each piece. Any earring that calls for a bead on the jump ring must have the bead oriented in between the earring and the hook so that it faces out when worn by the customer.

### 5) Rings:

### a) Power Ring

This is a blank ring which gives the customer the option of customizing through the company website. The customer will be able to have their name or date of significance printed/carved onto the surface of the ring (provided they obey the space constraint). The customer will also have the option of choosing a varied list of Power Words (e.g. “Win”, “Mean”, “Score”, etc.) to have printed on the surface of the ring. This product is unisex and will appeal to both genders.

### b) American Indian Ring

This is a ring with one continuous line forming many triangles with slightly rounded points across the length of the band. The points of the triangles are contained in the center of the band and do not touch the edge. Some rings will have the line carved into the surface down to the white layer, and some will have a line printed in black. This product is unisex and will appeal to both genders.

### c) Flower Petal Ring

This is a ring with a number of evenly spaced flowers carved into the surface of the band. The flowers are contained in the center of the band and do not touch the edge. To carve each flower the edge of a ‘U-shaped’ chisel is inserted just under the surface of the orange layer at a 45-degree angle. While still under the surface, the chisel is arced in a circular motion, cutting a circular shape into the surface of the material. Remove the chisel after about 270-degrees has been carved. No pieces of the material are removed. This makes one petal of a flower. If done correctly, you will have a 270-degree cut of a circle with the uncut 90-degree section oriented in the center. Then rotate the band and repeat the cut until you have a flower with 4 petals (with the uncut section in the center). Since the ‘U-shaped’ chisel is inserted at a 45-degree angle, the outer edge of each petal is thinner than the center. This gives the outline of each petal a ‘glowing’ appearance. This is a feminine product and will appeal more to the female gender.

### d) Hazard Ring

This is a ring with the word “HAZARD” centered on the band. Some rings will have the word carved into the surface, and some will have the word printed in black. As shown in the accompanying drawing, the letter “Z” is larger and more stylized than the other letters. This product is unisex and will appeal to both genders.

### e) Diamond Ring

This is a ring with a small triangle protruding from the top center and bottom center of the band. Each triangle measures ¼ of an inch in height. A diamond shape cutout is located in the center of the band, between the two triangles. The cutout measures ½ an inch in height and ¼ from side to side. This product is unisex and will appeal to both genders.

Note: A variety of ring sizes will be made to fit all size fingers, ranging from size 4 to 12. Two different sized widths will be made of each design: one measuring 1½ centimeters wide, and one measuring 1 centimeter wide. The two ends of each ring are attached by lacing strong thread through 3 corresponding holes on each end. The traffic cone material used for the rings must be thinner than the thickness used for the other pieces.

### 6) Wallet:

### Hazard Line Wallet

This is a standard sized wallet. The back is made of traffic cone material and the front is made of nylon (represented by the crosshatch lines). The back of the wallet displays the orange layer facing out. This back piece is scored on both sides at the two folding sites so that they fold easily. The inner nylon piece (with the plastic covered i.d. card slot on one panel, and credit card slots on the other 2 panels) is sewn to the left, bottom, and right edges of the inner white side of the traffic cone material back piece. This nylon piece is black (but other colored nylon can be used in other wallets as well). As is customary, the back piece of the wallet must be slightly longer than the inner nylon piece so that it folds correctly. As shown in the bottom accompanying drawing of the back view of the wallet, two male snap units are placed on the back right panel's left edge. As shown in the top accompanying drawing of the front view of the wallet, two female snap units are placed on the wallet's front left panel at the left edge. This way, when the wallet panels are folded closed, the male snap units line up with the female snap units and hold the wallet shut.

The blank orange surface of the back of the wallet gives the customer the option of customizing it through the company website. The customer will be able to choose from a varied list of Power Words, stock phrases, and stock graphics to have printed/carved on the surface of the wallet. The customer will also have the option of having their name or date of significance printed/carved onto the surface of the wallet. Not all of the wallets sold in stores will be blank. Different wallets will have the “HAZARD LINE” logo or a variety of graphics printed on the surface in black. This is a masculine product and will appeal more to the male gender.

### 7) Belts:

### a) Hazard Line Belt

This is a standard length and width belt made of traffic cone material. A standard metal belt buckle is attached to one end and the other end is rounded with holes for the buckle as is customary.

The blank orange surface of the belt gives the customer the option of customizing it through the company website. The customer will be able to choose from a varied list of Power Words, stock phrases, and stock graphics to have printed/carved on the surface of the belt. The customer will also have the option of having their name or date of significance printed/carved onto the surface of the belt. This product is unisex and will appeal to both genders.

### b) Snap Belt

This is a standard length and width belt made of traffic cone material. Snaps are used in place of a belt buckle. Both ends of the belt are rounded. On the right end of the belt are 5 female snap units centered in the middle and evenly spaced. On the left end of the belt are 3 male snap units centered in the middle and evenly spaced. This way, when the customer loops the belt through their pants, they can line up the snap units and snap them together in the front to form the hold.

The blank orange surface of the belt gives the customer the option of customizing it through the company website. The customer will be able to choose from a varied list of Power Words, stock phrases, and stock graphics to have printed/carved on the surface of the belt. The customer will also have the option of having their name or date of significance printed/carved onto the surface of the belt. This product is unisex and will appeal to both genders.

Notes: The edges of each belt will be sharp from the cutting process, and therefore, must be beveled smooth in order to prevent any skin irritation. The orange layer of the traffic cone material is always the side facing out.

### 8) Zipper Pulls:

This zipper pull is made from traffic cone material/plastic polymer/pvc and is in a plain teardrop shape. It measures about 1 inch in length, with a ring at one end so it can be attached to the zipper head. Other zipper pulls will be of varying designs and dimensions.

### 9) Belly Button Piercing:

This belly button piercing is made from the same standard metal components as other belly button piercings, but it has a diamond shaped design (made from traffic cone material/plastic polymer/pvc) attached to the bottom of the piercing. The piercing is of standard size. Other belly button rings will be of varying designs and dimensions.

### 10) Bookmarks:

This bookmark is made from traffic cone material/plastic polymer/pvc and is the standard rectangular bookmark size. On the surface is carved/printed “where are the pictures?” Other bookmarks will be of varying designs and dimensions. The customer will have the option of customizing blank bookmarks.

### 11) Bra:

This bra is made from both traffic cone material/plastic polymer/pvc and comfortable fabric. The crossing lines in the drawing represent the fabric, while the solid area represents the traffic cone material. The bra follows the same basic construction of other bras, except the outside of the cups are conformed by a traffic cone material veneer and the back clasp is a snap. The bra will be made to fit every major cup size. Other bras will be of varying design and dimension. The customer will have the option of customizing the outer cups.

### 12) Door Hanger:

This door hanger is the standard door hanger size and is made from traffic cone material/plastic polymer/pvc. Carved/printed on the surface is the expression “SHOO”. Other door hangers will be of varying designs and dimensions. The customer has the option of customizing blank door hangers.

### 13) Cell Phone/Beeper/Pager Holder:

This cell phone holder is made from traffic cone material/plastic polymer/pvc and measures 3×4×1 inches. There is an elastic band that connects the front and back sides of the case. The top of the case flips open and latches closed with a magnet. A loop is attached to the back surface of the case so that is can be worn on a belt. Other cell phone/beeper/pager holders will be of varying designs and dimensions. The customer has the option of customizing blank cell phone/beeper/pager holders.

### 14) Ipod Case:

This ipod case is made from traffic cone material/plastic polymer/pvc and is made to fit all major ipod sizes. There is an elastic band that connects the front and back sides of the case. There are cut-outs in the front of the case to allow the user to engage the screen and/or wheel. Other Ipod cases will be of varying designs and dimensions.

### 15) Cell Phone Charm:

This cell phone charm is made from traffic cone material/plastic polymer/pvc. This charm is of a small mushroom. A jump ring links the charm to a strap that loops through the cell phone. Other cell phone charms will be of varying designs and dimensions.

### 16) Wall Mask:

This decorative wall mask is made from traffic cone material/plastic polymer/pvc and measures 8 inches in height and 6 inches wide. This mask is in an abstract form of a skull with rectangular eye cut-outs, and slits making up the nostrils and mouth. Other wall masks will be of varying designs and dimensions.

### 17) Winter Hat/Beanie Hat

This winter/beanie hat is largely made of soft fabric (polyester, wool, cotton, etc) with a small rectangular tag on the brim made from traffic cone material/plastic polymer/pvc. The crossing lines in the drawing represent the fabric, while the solid area represents the traffic cone material. The tag reads “Hazard Line.” The hat will come in men's, women's, and children's sizes. Other winter/beanie hats will be of varying designs and dimensions. The customer will have the option of customizing the tag.

### 18) Baseball Cap:

This baseball cap is made from durable fabric with the brim made from traffic cone material/plastic polymer/pvc. The crossing lines in the drawing represent the fabric, while the solid area represents the traffic cone material. The baseball cap will come in men's, women's, and children's sizes. Other baseball caps will be of varying designs and dimensions.

### 19) Tie:

This tie is made from comfortable fabric (nylon, cotton, silk, etc) with the extreme of the broader end made from traffic cone material/plastic polymer/pvc. The crossing lines in the drawing represent the fabric, while the solid area represents the traffic cone material. Other ties will be of varying designs and dimensions.

### 20) Hoodie:

This hoodie is largely made from comfortable fabric (polyester, cotton, nylon, etc) with a small cutout of a “Z” made from traffic cone material/plastic polymer/pvc sewn onto the left breast of the hoodie. The crossing lines in the drawing represent the fabric, while the solid area represents the traffic cone material. This hoodie will come in men's, women's, and children's sizes. Other hoodies will be of varying designs and dimensions.

### 21) Satchel Bag:

This satchel bag is made mostly from traffic cone material/plastic polymer/pvc with some areas of durable fabric. The crossing lines in the drawing represent the fabric, while the solid area represents the traffic cone material. Durable fabric connects the front and back sides of the bag. The back side extends into a large flap that curls over the top opening of the bag and rests over the front side. There is a strap attached to the side fabric on each side of the bag. A fabric covered cushion is attached to the middle of the strap for comfort. Other satchel bags will be of varying designs and dimensions. The customer will have the option of customizing the large flap of the bag.

### 22) Sneaker:

This sneaker is made from traffic cone material/plastic polymer/pvc and durable fabric. The sneaker will be made just like regular sneakers, except the toe and the heel areas will be covered by a traffic cone material veneer. The crossing lines represent the fabric, while the solid areas of the toe and heel represent the traffic cone material. The shoe will be made to fit all major shoe sizes for men, women, and children. Other shoes will be of varying designs and dimensions.

### 23) Decal Snaps:

This decal snap is made from traffic cone material/plastic polymer/pvc and a metal snap. It is a circular disc of material with the runic symbol “Jera” carved/printed onto the surface. It would snap onto other articles of clothing/accessories already adorned with the female end of the snap. Other decal snaps will be of varying designs and dimensions.

### 24) Money Clip:

This money clip is of a standard money clip design. It is made mostly from a durable metal alloy with a strip of traffic cone material/plastic polymer/pvc running down the front of the clip. The plastic strip would be anchored onto the money clip with small screws or rivets. Other money clips will be of varying designs and dimensions.

### 25) Magnet:

This magnet is made from traffic cone material/plastic polymer/pvc with an adhesive magnetic strip on the back. This rectangular magnet has a cherry blossom branch carved onto the surface. Other magnets will be of varying designs and dimensions.

### 26) Backpack:

This backpack is made from a combination of traffic cone material/plastic polymer/pvc and durable fabric (such as nylon). The crossing lines represent the durable fabric while the solid areas of the sketch are made from traffic cone material. The body and side pouches of the backpack are made from fabric and the two front pouches, the top handle, and the zipper pulls are made from traffic cone material. The lower front pouch has the Hazard Line “Z” carved onto the surface. Other backpacks will be of varying designs and dimensions.

### 27) Watch Band:

This watch band is made from traffic cone material/plastic polymer/pvc. It has the same shape and dimensions as a standard wrist watch band. Different watch designs can be clipped in at the junction of the two strips. One of the ends will have a standard watch buckle. Other watch bands will be of varying designs and dimensions.

### 28) Relief Carving:

These relief carvings are made from traffic cone material/plastic polymer/pvc. They are large pieces of material with scenes and images carved onto their surfaces. The top piece represents a cherry blossom branch and the bottom piece is of a hand with small vines on either side of it. Other relief carvings will be of varying designs and dimensions.

### 29) Eyeglass Case:

This eyeglass case is made from traffic cone material/plastic polymer/pvc. A rectangular strip of said material will have small holes punched around the perimeter on three sides and scored down the middle. The rectangle will be folded over and the holes will be sewn together with lanyard string. The customer will have the option of customizing the outside surface of the eyeglass case. Other eyeglass cases will be of varying designs and dimensions.

### 30) Headband:

This headband is a thin, rigid traditional headband with teeth that has a wider veneer made from traffic cone material/plastic polymer/pvc. The veneer is anchored to the rigid head band by either small screws or strong adhesive. The veneer is a plain solid color with no other distinguishing marks. The customer will have the option of customizing the outside surface of the headband veneer. Other headbands will be of varying designs and dimensions.

### 31) Coaster:

This coaster is made from traffic cone material/plastic polymer/pvc. It is a square piece of the material with a number of vertical lines scored into the surface with a chisel. It will have standard coaster dimensions. Other coasters will be of varying designs.

### 32) Car Decoration:

This car decoration is made from traffic cone material/plastic polymer/pvc. It is a flat piece of material that is scored to look like a three-dimensional die. Hole punches represent the dots on each side. A looped string is attached to the top of the decoration so that it can be hung in varying areas of a car cabin, i.e. the rear view mirror. It will measure 3 inches in height and 3 inches wide. Other car decorations will be of varying designs and dimensions.

### 33) Ornament:

This ornament is made from traffic cone material/plastic polymer/pvc. It is an oblong cut-out measuring 3 inches in height and 1 inch wide. It has a number of diagonal cuts scored into the surface with a chisel. The ornament has a looped string attached to the top so that it can be hung up. Some other ornaments will be customizable. Other ornaments will be of varying designs and dimensions.

### 34) Pet Products:

These pet products (including collar and identification tag) are made from traffic cone material/plastic polymer/pvc. The collar has a standard plastic snap clasp and a metal ring that can be hooked onto a leash. The collar will be made in a variety of sizes to fit different sized dogs and cats. The band is plain with no distinguishing marks, but it can be customizable. The identification tag is a circular cutout of the material and has a diameter of about 1 inch. It is customizable; this one displaying the name of a pet. It has a jump ring at the top so it can be attached to the collar. Other pet products will be of varying designs and dimensions.

### 35) Hair Clip:

This hair clip is made from traffic cone material/plastic polymer/pvc. A standard metal hair clasp is mounted onto a veneer of the material with small screws. This design is of a bowtie shape with a number of diagonal cuts scored into the surface with a chisel. It measures 1.5 inches in height and 3 inches wide. Other hair clips will be of varying designs and dimensions.

### 36) Change Purse:

This change purse is made from traffic cone material/plastic polymer/pvc. A strip of material will have small holes punched down the perimeter on the two longer sides. One end will terminate in a blunt point. The strip will be scored horizontally in two places on the underside white layer of the material. The strip will be folded over and the holes will be sewn together with lanyard string. The top flap will then fold over this and snap shut. The colored layer will be the one that faces outward. The customer will have the option of customizing the outside surface of the change purse. Other change purses will be of varying designs and dimensions.

### 37) Purse:

This purse is made from traffic cone material/plastic polymer/pvc. The main body of the purse is one large piece of material that loops around and snaps onto itself. The shoulder strap is also made from said material. The crossing lines represent durable fabric which will be sewn into the left and right sides of the purse so that items will not fall out. The purse measures 5 inches in height and 11 inches wide. The outside surface of the purse will be customizable. Other purses will be of varying designs and dimensions.

### 38) Pins/Buttons:

These pins/buttons are made from traffic cone material/plastic polymer/pvc. They are circular cutouts of the material that have been attached to a spring pin mechanism so that they can be worn on clothing and bags. They measure 1.5 inches in diameter. The three pins/buttons represent three possible designs: a spider web, “vote me”, and a yin yang. People will have the option of customizing the pins/buttons. Other pins/buttons will be of varying designs and dimensions.

### 39) Anklet:

These anklets are made from traffic cone material/plastic polymer/pvc. The top sketch represents an elastic band with beads made from said material. A musical note charm is attached to it. The bottom anklet sketch is a strip of said material with holes punched along the middle. It is connected by a small snap. Different sizes will be made to fit a variety of ankle sizes. Other anklets will be of varying designs and dimensions.

### 40) Lanyard:

This lanyard is made from traffic cone material/plastic polymer/pvc. It is a rectangular piece of said material that is attached to a key ring with a jump ring. It measures 5 inches in height and 1.5 inches wide. Hole punches run down its length. Other lanyards will be of varying designs and dimensions.

### 41) Nose Piercing:

This nose piercing is made of standard nose piercing metal (steel/sterling silver) with a bead made from traffic cone material/plastic polymer/pvc threaded on it. Two colored plastic/stone beads are threaded on either side of the traffic cone bead. Other nose piercings will be of varying designs and dimensions.

### 42) Charms:

This charm is made from traffic cone material/plastic polymer/pvc. It measures about 1 inch in height and 1 inch wide. This particular charm is of a small mushroom. The dots represent different color traffic cone inserts and the diagonal lines on the stem indicate that the colored layer of said material is shaved down to the white layer. Other charms will be of varying designs and dimensions.

### 43) Button:

This button (meant to be sewn on clothing) is made from traffic cone material/plastic polymer/pvc. It is the same design as a standard clothing button. This button measures ½ inch in diameter but other buttons will be of varying designs and dimensions.

### 44) Cufflinks:

These cufflinks are small square cutouts of traffic cone material/plastic polymer/pvc that are anchored onto standard metal cufflink mechanisms. The squares measure ½ inch on each side and have a number of diagonal lines scored into the surface with a chisel. Other cufflinks will be of varying designs and dimensions.

Except the above detailed description of the fashion accessories within this invention, the following features are also important to the Hazard Line products:

The customer should know that the traffic cone material glows under a black light (ultra-violet light), making it an ideal accessory for bars, clubs, and parties. It is a good marketing ploy.

Different lines of Hazard Line products can periodically come out in different color sets: e.g.: blue, purple, yellow, red, black, green, indigo, maroon, violet, etc. This means that the top orange layer will be died a different color, while still retaining the white layer.

A line of Hazard Line products can look as though it is splattered with dirt (the way a real traffic cone would be). This simulated dirt splatter would be printed on with brown and black ink.

Customers will have the option of choosing different lengths of chain for the pendant they want to purchase. They will be able to choose from lengths of: 16″, 18″, 20″, 22″, 24″, and 30″

A number of products call for a black colored metal snap. It needs to be guaranteed that the black color will not scratch off the metal snap and make the product look bad.

In addition, the following lists of edgy phrases and individual words can be used in these fashion accessories.

### List of Attitudes

This is a list of edgy phrases called “Attitudes”. The customer will have the option of choosing a phrase from this list to have custom printed/carved onto the surface of their product of choice (bracelets/wallets/belts). Some of these phrases will already be printed/carved on the surface of select products.

| | | |
|---|---|---|
| You Love My Blondeness | That's Redonkulous! | Feel My Awesomeness |
| U Wish U Were Me | Like OMG | Use More Tongue |
| Young and Reckless | Wait, What? | #1 Gossip |
| #1 [symbol] | Ladies, One at a Time | High Roller |
| I Can Bench You | Future Model | #1 [symbol] Model |
| Future Screw-up | Vote Me | Youtube Addict |
| Facebook Addict | Future Convict | [symbol] My Life |
| Say No to Silence | International Sex Symbol | ½ Man, ½ Rockstar, |
| | | ½ Bad at Math |
| You're Hot | Crazy Like a Fox | Awesomely Awesome |
| Your Face Just Scared Me | Meet Me in the Back Seat | Sex Guru |
| Hotter Than You | Not Quite Sober | Panties<Thong<No Thong |
| Caffeine Enhanced | 100% Jock | 100% Not Interested |
| I'm Done With You | I Forgot You Were Here | Certified Badass |
| The Big Dog | Videogame Addict | Sexiest Nerd Alive |
| Stop Picturing Me Naked | Magic Sauce | Skinny Bitch |
| Big Hands, Big Feet, Big Fun | Blood Type: Coffee | Blood Type: Beer |
| I Like Shiny Things | Future Cougar | Bad With Names |

[symbol]

indicates data missing or illegible when filed

### List of Power Words

This is a list of individual words called “Power Words”. The customer will have the option of choosing a word from this list to have custom printed/carved onto the surface of their product of choice (bracelets/pendants/rings/wallets/belts). Some of these words will already be printed/carved on the surface of select products.

| | | | |
|---|---|---|---|
| Win | Pump | Score | Mean |
| Rebel | Compete | Race | Run |
| Fly | Punch | Hit | Kick |
| Dance | Play | Contact | Go |
| Touch | See | Live | Jump |
| Dive | Explore | Fight | Earn |
| Thrive | Dare | Be | Risk |
| Rise | Push | Vie | Chase |
| Create | Bitch | Urban | Luck |
| Lock | Heat | Hot | Man |
| Woman | Hero | Ripped | Jacked |
| Power | Sexy | Sleek | Shredded |
| Unstoppable | Fearless | Proud | Scare |
| Reckless | Know | Smart | Confidence |
| Self | Soul | Me | Us |
| Love | Time | Loud | American |
| Mexican | Italian | Irish | German |
| Indian | French | Russian | Spanish |
| Korean | Chinese | Japanese | Polish |
| Swedish | Dutch | African | Australian |
| Canadian | New York | California | *(every other |
| | | | US state) |
| Kiss | Party | Hug | |
| Screw | Find | Achieve | Fix |
| Fate | Lead | Leader | Tribal |
| Mingle | Drive | Wild | Naked |
| New | Pure | Good | Bad |
| Naughty | Nice | Sweet | Sour |
| Cool | Ice | Act | Write |
| Storm | Laugh | Enjoy | Vibe |
| Build | Buy | Sell | Swipe |
| Cheat | Burn | Bust | Model |
| Strut | Sway | Invent | Leap |
| Skate | Trick | Twirl | Summer |
| Breeze | Coast | Help | Brave |
| Bravery | Overcome | Pass | Paint |
| Draw | Carve | Challenge | Break |
| Free | Jam | Design | Bliss |
| Happy | Expert | Happiness | Pro |
| Awesome | Exceed | Demand | Speak |
| Shine | Glow | Swim | Ride |
| Feel | Seek | Fast | Clutch |
| Diesel | Plug | Fuel | Energy |
| Braver | Strong | Sexier | Stronger |
| Sleeker | Faster | Sweeter | Hard |
| Harder | Wilder | Louder | Smarter |
| Hotter | Luckier | Crazy | Crazier |
| Relax | Breathe | Pierce | Flex |
| Bolt | Ski | Stoke | Rev |
| Charge | Pin | Improve | Passion |
| Instinct | Lust | Amp | Voltage |
| Hazard | Drift | Flip | Taste |
| Sense | Blitz | Swing | Rude |
| Tease | Venom | Hazardous | Venomous |
| Sing | Snooze | Surf | Shift |
| K.O | Nerve | Venom | Clap |

Although the fashion accessories and the method of using the same according to the present invention has been described in the foregoing specification with considerable details, it is to be understood that modifications may be made to the invention which do not exceed the scope of the invention and modified forms of the present invention done by others skilled in the art to which the invention pertains will be considered infringements of this invention when those modified forms fall within the claimed scope of this invention.

What is claimed is:

1. A series of fashion accessories designed and made from traffic cone rubber include but not limited to Bracelets, Key Chains, Necklace Pendants, Earrings, Rings, Wallet, Belts, Zipper Pulls, Belly Button Piercing, Bookmarks, Bra, Door Hanger, Cell phone/Beeper/Pager Holder, Ipod Case, Cell Phone Charm, Wall Mask, Winter Hat/Beanie Hat, Baseball Cap, Tie, Hoodie, Satchel Bag, Sneaker, Decal Snaps, Money Clip, Magnet, Backpack, Watch Band, Relief Carving, Eyeglass Case, Headband, Coaster, Car Decoration, Ornament, Pet Products, Hair Clip, Change Purse, Purse, Pins/Buttons, Anklet, Lanyard, Nose Piercing, Charms, Button, and Cufflinks.

2. The traffic cone rubber of claim 1 is the same rubber polymer used in regular traffic cones which have overall thickness of 3.75 mm+/−0.05 mm with two layers (orange over white), wherein the orange layer has thickness of 1.32 mm+/−0.025 mm and the white layer has thickness of 2.43 mm+/−0.025 mm.

3. The traffic cone rubber of claim 1 glows under ultra-violet light with the same durability, flexibility, carvability, elasticity, and durometer as traffic cone material.

4. Each of these fashion accessories of claim 1 comprises different designs or styles described within this invention, wherein Bracelets include Leopard style, Hazard style, Phrase Band style, and Flower Petal style, Hazard Braid style, and Stripper style; wherein Key Chains include designs of Rebel Head Smirk, Rebel Head Jax, Rebel Head Blaa, Rebel Head Lips, Skull, Flower, Rebel Head Texty, Rebel Head Punchy, Rebel Head Winks, Mushroom, and Sea Shell; wherein Necklace Pendants include designs of Sunrise, Bubble Heart, Crossroads Heart, Electric Heart, Double Spike, Petal Pendant, Shift, Power Word, Runic, Grecian, Arrowhead, Dog Tags, Hazard Amulet, Icicle, Clover, Hazard Guy, Dragonfly, and Hazard Chick; wherein Earrings include designs of Flower Petal, Fang, Industrial, Hazard Moon, and Venom; wherein Rings include styles of Power Ring, American Indian Ring, Flower Petal Ring, Hazard Ring, and Diamond Ring; wherein Wallet includes Hazard Line Wallet style; wherein Belts include styles of Hazard Line Belt and Snap Belt.

5. Some of these fashion accessories of claim 1, wherein individual words called “Power Words” and/or edgy phrases called “Attitudes” are engraved.
